(19) United States
(12) Patent Application Publication
(10) Pub. No.: US 2014/0365901 A1
(43) Pub. Date: Dec. 11, 2014

(54) PUSHING MAP INFORMATION FROM A DEVICE TO OTHER DEVICES

(71) Applicant: Apple Inc., Cupertino, CA (US)

(72) Inventors: Alexandre Moha, Paris (FR); Julien Robert, Paris (FR); Matthew B. Ball, South San Francisco, CA (US); Justin Wood, Sunnyvale, CA (US)

(73) Assignee: Apple Inc., Cupertino, CA (US)

(21) Appl. No.: 14/064,099

(22) Filed: Oct. 25, 2013

Related U.S. Application Data
(60) Provisional application No. 61/832,900, filed on Jun. 9, 2013.

(51) Int. Cl. G06F 3/0484

(52) U.S. Cl. CPC G06F 3/04842
USPC 715/738

(57) ABSTRACT

A method of sending map related information from a device to a set of associated devices is provided. The method displays a map on a display screen of a first device. The method receives a request to share map information with other associated devices. The method displays a list of a set of devices associated with the first device. The method receives a selection of one or more devices in the set of devices. The method identifies the map information to share based on a set of criteria. The method sends the identified map information from the first device to the identified devices.

### BACKGROUND

Many electronic devices such as desktops, laptops, tablet devices, smartphones, etc., include mapping and navigation applications. Most of these applications generate displays of a map based on map data that describes relative locations of streets, highways, points of interest, etc., in the map.

Some mapping and navigation applications provide tools for searching for points of interest and addresses. Users can select the search results, points of interest, or addresses and read detailed information cards associated with these locations. Some mapping and navigation applications provide photos, phone numbers, addresses, web sites, etc., related to a selected location of the map. Some mapping and navigation applications allow the user to see different routes between source and destination addresses and get turn-by-turn directions. Users can mark points of interest and addresses on a map by dropping marker pins on these locations. Some mapping and navigation applications allow bookmarking the information cards associated with different locations on the map.

### BRIEF SUMMARY

Some embodiments provide a method to push map information from one device to other devices. Some embodiments display a menu after a share button is selected. The displayed menu shows a set of options that includes sending the displayed map information to a device. In some embodiments, the menu allows selection of any devices such as phones or touchpads that are bounded or registered to the same user through a network account.

Different embodiments provide different criteria to identify the map information to share. When a route is displayed on the map, some embodiments send the route information to the selected device. Points of interest and pins can be selected to show a detailed card that includes a share button to push the information. Search results can also be shared in some embodiments. When no route or search results are shown and no point of interest or pin is selected, the viewed geographic region at the same zoom level is shared with the selected device. Some embodiments include selected cards, routes, or bookmarks in a recents list and automatically synchronize the list to other devices. Some embodiments also provide a send to all option to send the shared map information to all other associated devices. When the first associated device accepts and displays the shared information, all other associated devices are notified and discard the shared information.

The receiving device displays a notification when the shared information is received. When the receiving device is locked, acceptance of the notification is used to unlock the device. When the mapping and navigation application is running in the foreground of the receiving device, the shared map information is displayed after the acceptance of the notification. When mapping and navigation application is not running in the foreground, the currently running application is switched with the mapping and navigation application. If the shared information included a route, the user can start navigation by selecting a single button.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates sharing map information between two devices in some embodiments of the invention.

FIG. 2 conceptually illustrates a user interface for sharing a route in some embodiments of the invention.

FIG. 3 conceptually illustrates a user interface for sharing a point of interest on a map in some embodiments of the invention.

FIG. 4 conceptually illustrates a user interface for sharing a currently displayed map view with other devices in some embodiments of the invention.

FIG. 5 conceptually illustrates a user interface for sharing a search result in some embodiments of the invention.

FIG. 6 conceptually illustrates a user interface for sharing a search query in some embodiments of the invention.

FIG. 7 conceptually illustrates another example of a user interface for sharing a location in some embodiments of the invention.

FIG. 8 conceptually illustrates a process for sending map information from a device to a set of associated devices in some embodiments of the invention.

FIG. 9 conceptually illustrates a user interface for sharing map information with multiple devices in some embodiments of the invention.

FIG. 10 conceptually illustrates receiving shared map information at a device while the device is in locked mode in some embodiments of the invention.

FIG. 11 conceptually illustrates receiving map information while the mapping and navigation application is running in the foreground in some embodiments of the invention.

FIG. 12 conceptually illustrates receiving map information while the mapping and navigation application is not running in the foreground in some embodiments of the invention.

FIG. 13 conceptually illustrates a process for receiving map information that is pushed into a device from another device in some embodiments of the invention.

FIG. 14 conceptually illustrates a system level diagram for getting a list of associated devices and sending map related information from one device to other devices in some embodiments of the invention.

FIG. 15 conceptually illustrates a client side diagram for pushing map information from one device to other device in some embodiments of the invention.

FIG. 16 conceptually illustrates the use of recents list to share map information among different devices in some embodiments of the invention.

FIG. 17 is an example of an architecture of a mobile computing device with which some embodiments of the invention are implemented.

FIG. 18 conceptually illustrates another example of an electronic system with which some embodiments of the invention are implemented.

FIG. 19 illustrates a map service operating environment, according to some embodiments.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

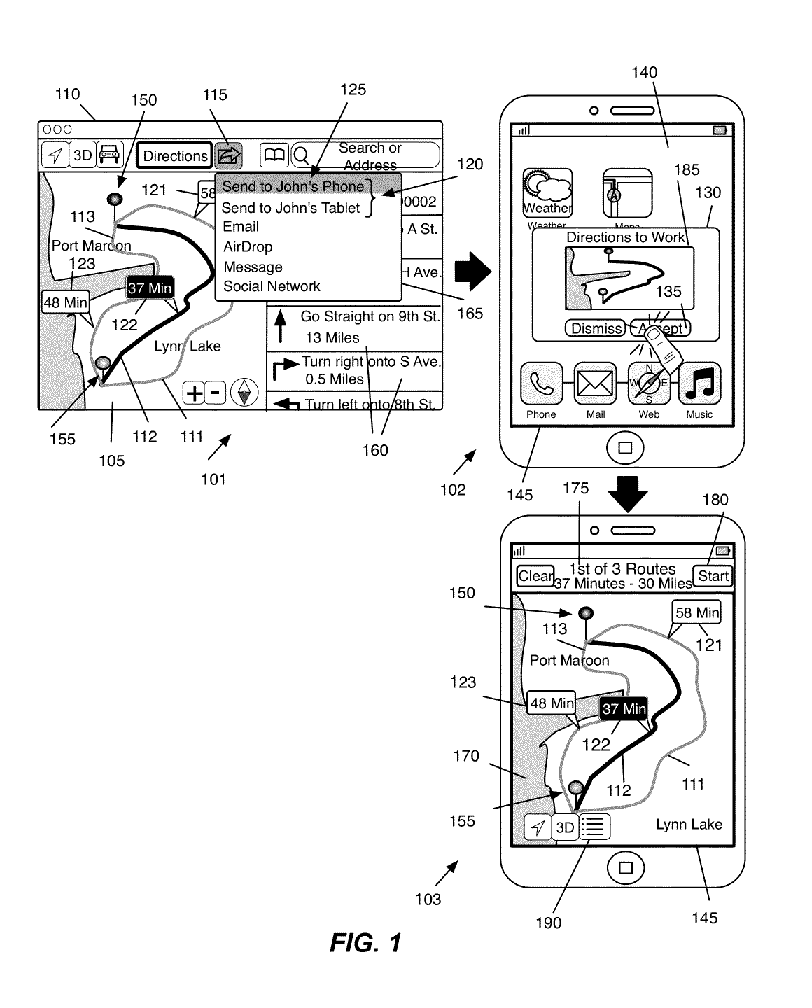

Some embodiments provide a system and method for sharing map information among different devices. For instance, a user that has a current view on a map displayed on her device or has identified a route or a point of interest on a map can push the map information to one or more other devices. FIG. 1 conceptually illustrates sharing map information between two devices in some embodiments of the invention. The figure is shown in three stages 101-103. As shown, in stage 101 a region of a map 105 is displayed on the display screen 110 of the first device.

In the example of FIG. 1, the map information to share includes several routes 111-113. The map also shows the estimated travel time 121-123 for each route. The starting and destination locations for the route are identified by their corresponding pins 150 and 155. The turn-by-turn directions 160 are also displayed on the first device display screen 110.

When a share button 115 is activated to share map information with other devices, a share menu 165 that includes a list 120 of devices is displayed on the display screen 110 of the first device. The list shows the devices that the first device is authorized to share the map information. Authorizing devices to share map information with each other is described in more detail below. In the example of FIG. 1, a second device 125 (John's Phone) is selected to receive the map information. Once a device is selected to share the map information, the map information is pushed to the selected device.

In stage 102, the second device receives a notification 130 that map information to share is received. In this example, the notification is in the form of “directions to ‘destination’” alert. The notification in some embodiments includes an icon or a small image 185 of a map. In some embodiments, the displayed small map is a smaller version (or an icon made) of the actual map to be displayed. In other embodiments, the small image is a generic image of a map. Yet in other embodiments (e.g., when the device is in locked mode), the notification does not include an image of a map.

As shown in stage 102, the mapping and navigation application is not running in the foreground when the second device receives the notification 130. In this example, the home screen 140 is displayed on the display screen 145 of the second device. In stage 102, the request to receive the information is accepted (e.g., after an accept button 135 is selected).

As shown in stage 103, the application 140 that was running in the foreground of the second device is replaced by the mapping and navigation application, which has displayed a portion of a map 170 on the display screen 145 of the second device. In some embodiments, the same view (e.g., the same region, the same zoom level, the same camera view, same two-dimensional (2D) or three-dimensional (3D) map, etc.) of the map 105 that was displayed on the first device is displayed on the second device. The map 150 in the illustrated embodiment includes the same pins 150 and 155, routes 111-113, and estimated travel time estimates 121-123 as the map 105 displayed on the first device. In other embodiments, some of the information such as the pins and/or the estimated times are not sent from the first device to the second device unless specifically selected on the first device as items to share.

In the example of FIG. 1, the first and second devices are of different types (e.g., the first device is a desktop and the second device is a smart phone) with different display sizes and different display proportions. As shown in stage 103, the turn-by-turn directions 160 for the route 112 that was displayed on the first device is replaced by a route summary 175 on the second device. The turn-by-turn directions in some embodiments are displayed when a control (e.g., button 190) is selected.

In some embodiments, the turn-by-turn directions on a device with a small display screen (e.g., devices with a display that is smaller than a predetermined size or certain type of devices such as mobile phones) are displayed on a separate page. In other embodiments, or on other devices the turn-by-turn directions are shown on the same page. When the location of the second device is the same or in the vicinity of the starting point of the route, navigation along the route can be started from the second device by a command (e.g., by selecting button 180) to start navigation.

Several more detailed embodiments of the invention are described in sections below. Section I discusses sharing map information with other devices. Next, Section II describes receiving the shared map information by one or more devices. Section III describes the architecture for pushing map information of some embodiments. Section IV provides a description of an electronic system with which some embodiments of the invention are implemented. Finally, Section V describes the map service environment of some embodiments.

I. Sharing Map Information with Other Devices

Some embodiments provide a system for pushing map information from one device to other devices. In these embodiments, a device shares information such as routes and directions between two points (e.g., points of interest, dropped pins, search results, contact addresses), a selected pin, a point of interest, a search query, a map region, etc., with the other devices.

A. Selection of Map Information to Share

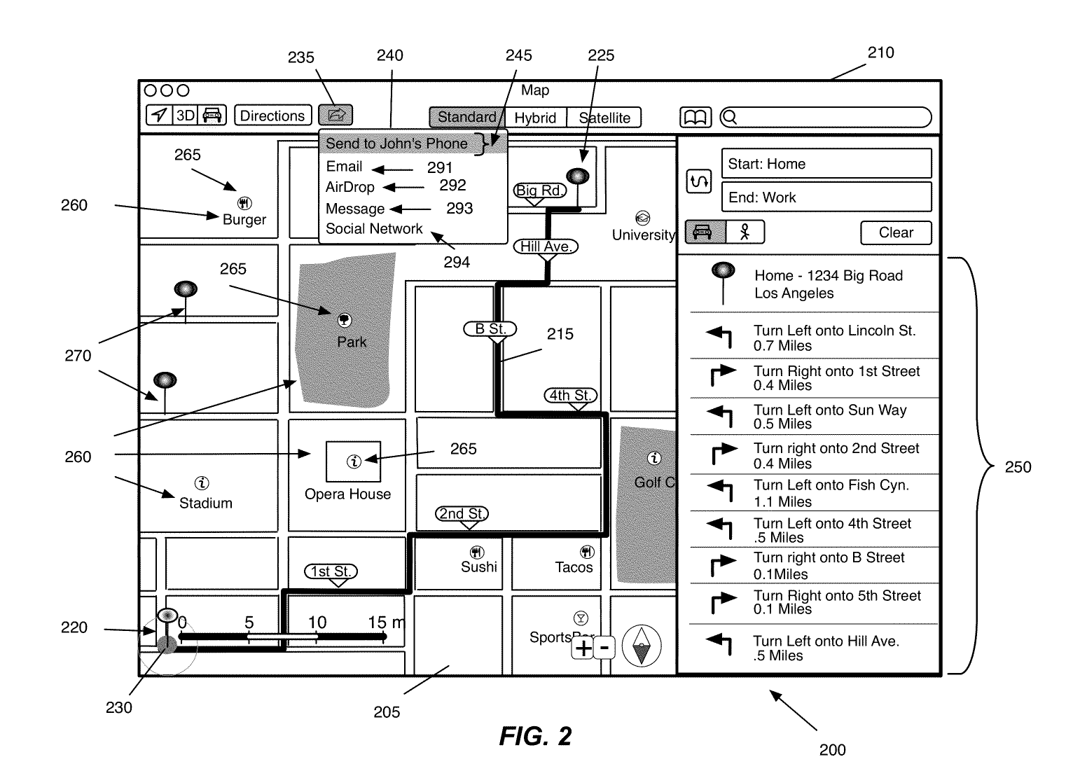

FIG. 2 conceptually illustrates a user interface 200 for sharing a route in some embodiments of the invention. As shown, a potion of a map 205 that shows a particular region is displayed on the display screen 210 of the device. The map shows a route 215 between a starting (or source) location and a destination location, which are identified by their corresponding pins 220-225. The current location 230 of the device is also shown on the map 205. Turn-by-turn directions 250 from the source to destination are also displayed.

The map also shows points of interest 260 and pins 270 that are dropped on different locations on the map. Some points of interest include an information button 265 that provides more information about the point of interest when the buttons 265 are selected. Selecting a dropped pin 270 in some embodiments results in displaying more information (e.g., a street address) about the location corresponding to the pin.

Some embodiments provide different ways of selecting the map information to share. As shown in FIG. 2, the user interface 200 provides a share button 235 for sharing map related information. Selecting the share button 235 opens a share menu 240 that includes a list 245 of one or more devices (in this example only one device) to share the route information. Selection of a device from the list 245 results in sending the information about the route to the selected device.

As shown, the share menu 240 includes several more options 291-294 for sharing the map information in addition to pushing the map information to the devices in the list 245. The user interface provides the option to share the map information through email 291, peer-to-peer communication 292, text message 293, one or more social networks 294, etc. For instance, sharing the information using the peer-to-peer communication 292 allows the device to discover nearby devices and sending the map information through a short-range peer-to-peer communication channel. Peer-to-peer (or P2P) communication allows devices to send information directly to one another without sending the information through a centralized server. The devices can discover and directly communicate with each other through wireless channels by sending signals from the antenna of the sending device to the antenna of the receiving device without the signals going through any other intervening infrastructure access points, gateways, servers, or cellular base-stations. Wireless technologies such as Wi-Fi, Bluetooth® or other short-range communication methods are used in different embodiments to provide connectivity without a need for a gateway or an access point.

Different embodiments utilize different criteria for sharing map information between devices. Some embodiments assign priorities to different items that are displayed on a map and send the information to other devices according to the priority of the displayed items. For instance, some embodiments give a higher priority to a route than any other information on the map and send the route information to selected devices when a route is displayed. In some of these embodiments dropped pins 270 and/or search queries (if any) are not sent if a route is displayed on the map. In other embodiments, some or all other information currently displayed on the map are also sent along with the route. In some embodiments, the information regarding the turn-by-turn directions is also sent to the selected device along with a route.

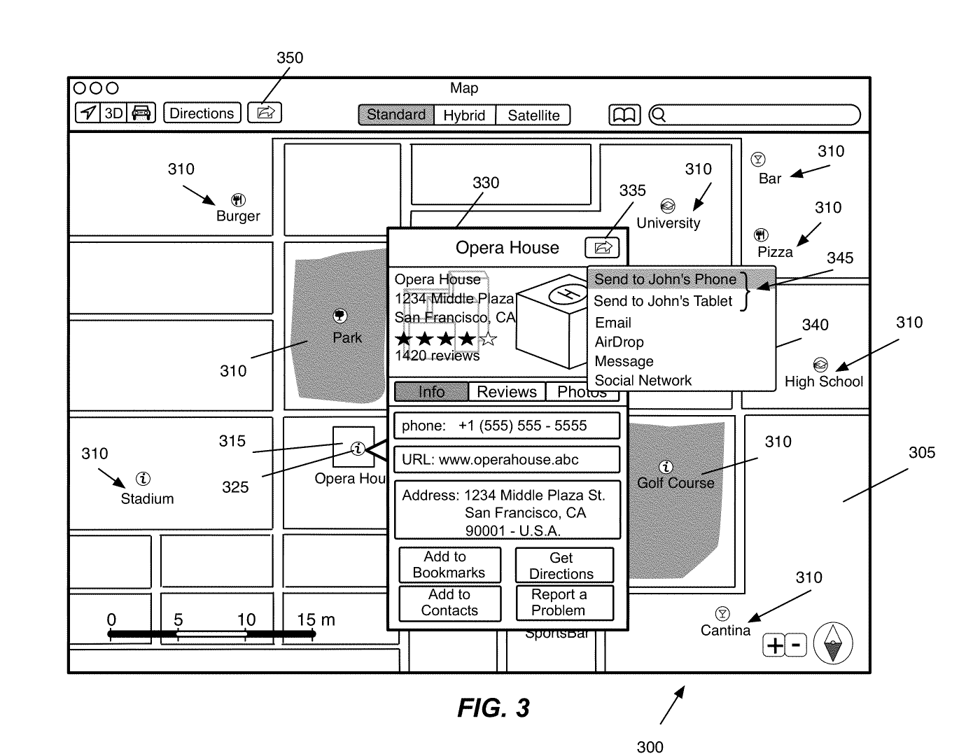

In some embodiments, when there are no routes, dropped pins, or search queries displayed, the information about the map region is sent to other devices. In some embodiments, when an item is currently selected on a map, the selected item gets the highest priority to share with other devices. As described by reference to FIG. 3 below, when a particular item such as a point of interest or a pin is selected on a map, some embodiments display an information menu for the selected item is displayed, which includes an additional search button.

FIG. 3 conceptually illustrates a user interface 300 for sharing a point of interest on a map in some embodiments of the invention. The map 305 in FIG. 3 includes several points of interest 310-315. As shown, one of the points of interest 315 is currently selected. Selection is made in some embodiments by either selecting an information button 325 or selecting the displayed point of interest. The selection of the point of interest 315 in some embodiments opens an information menu 330 (e.g., an information card) that includes additional information about the point of interest. In this example, the information card 330 includes the name, address, phone number, web address, and different options to get additional information or save the information about the point of interest.

The information card includes a share button 335 to share the information. Selection of button 335 opens a share menu 340. The share menu 340 includes a list 345 of several devices to share the information about the point of interest. Selection of one or more of the devices in the list 345 results in the information regarding the selected point of interest to be sent to the selected devices. In some embodiments, selection of the share button 350 after menu 330 is displayed also results in share menu 340 and the list 345 of the devices to be displayed. In this example, the selected information receives the highest priority and is the information that is sent to the selected device.

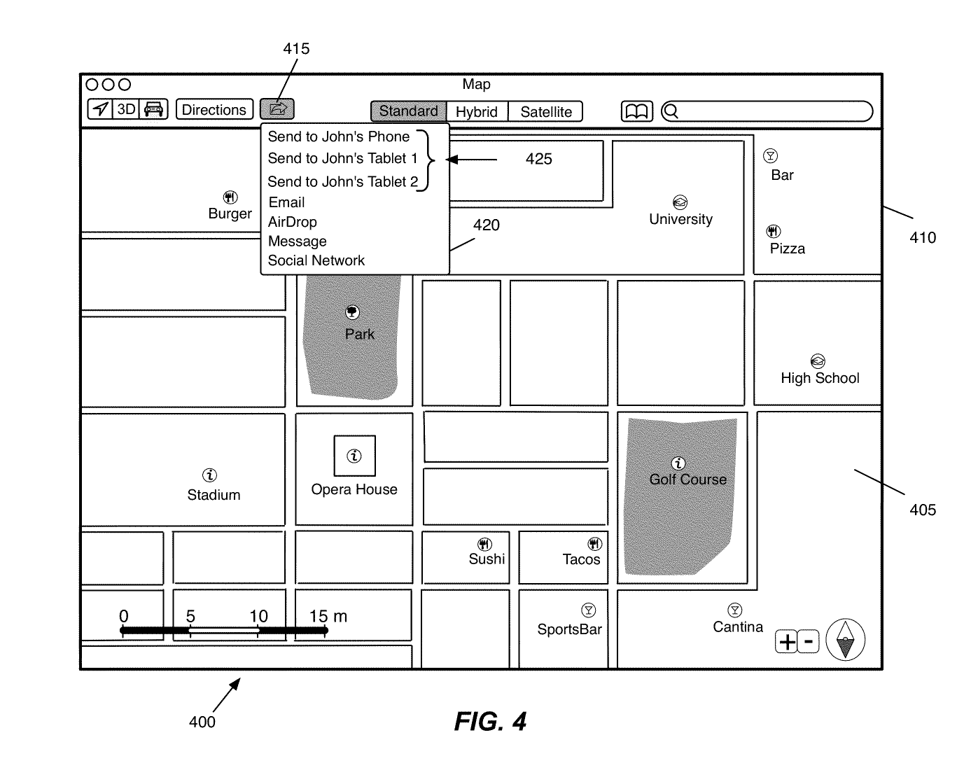

FIG. 4 conceptually illustrates a user interface 400 for sharing a currently displayed map view with other devices in some embodiments of the invention. As shown, a portion of a map 405 that shows a particular region is displayed on the device display screen 410. As shown, the user interface provides a share button 415 for sharing the currently displayed map information. In the example of FIG. 4, no particular item is selected on the map and there are no routes, dropped pins, or search queries displayed. The current view of the map 405 is, therefore, shared with the selected devices.

Once the share button 415 is selected, a share menu 420 is displayed that includes a list 425 of several devices. After one or more of the devices in the list 425 are selected, the information about the map region displayed on the current device is shared with the selected device or devices. In some embodiments, the information about the map region is the information required to regenerate the same map on the receiving devices. For instance, the map region information includes one or more of the coordinates of the region, name of the region, zoom or the hierarchical level of the map region, the current camera view, whether the map is displayed as a two-dimensional (2D) map or a three-dimensional (3D) map, etc.

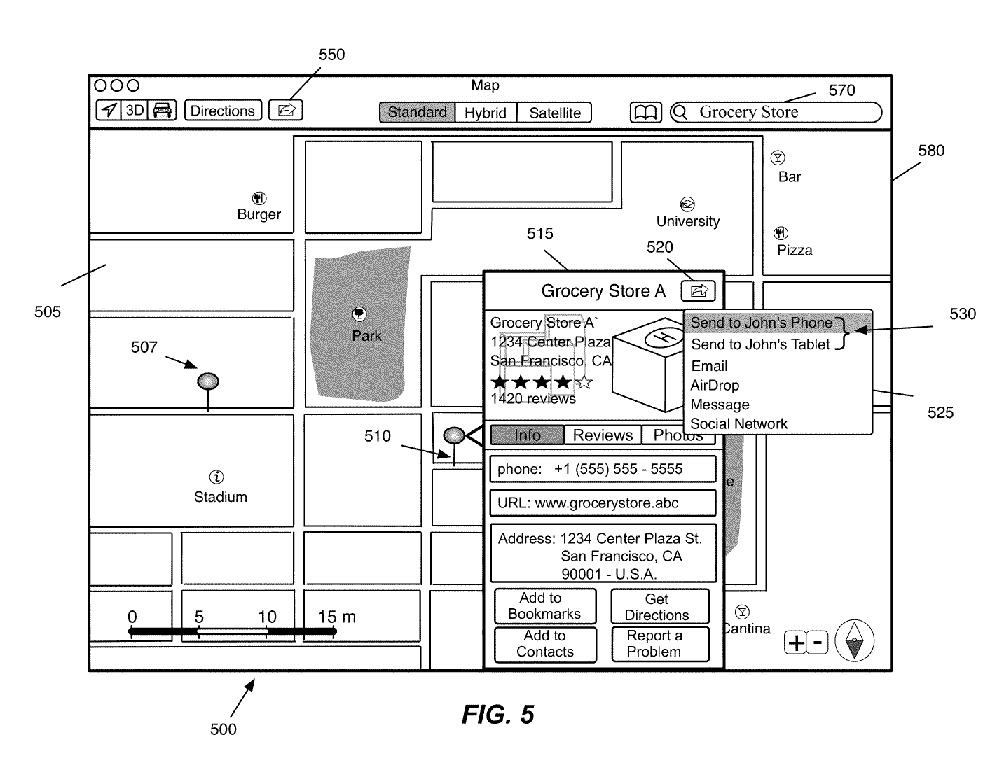

FIG. 5 conceptually illustrates a user interface 500 for sharing a search result in some embodiments of the invention. As shown, a potion of a map 505 is displayed on the display screen 580 of the device. The map shows a pin 510 that marks a location on the map 505. Dropping a pin allows a user to mark a location on the map, e.g., after searching for an address or identifying a location on the map that interests the user. A pin provides an easy way of identifying a location and getting directions to the pin or from the pin.

In the example of FIG. 5, the pins 507-510 were dropped after a search (as shown in the search field 570) for a grocery store resulted in finding several grocery stores. As shown, after the pin 510 associated with “Grocery Store A” is selected, an information menu (e.g., an information card) 515 is displayed with information about the grocery store.

Selecting the button 520 opens a share menu 525 that includes a list 530 of one or more devices to share the pin information. Selection of one or more devices from the list 530 results in sending the information about the pin to the selected devices. In some embodiments, selection of the share button 550 after menu 515 is displayed also results in the share menu 525 and the list 530 of the devices to be displayed.

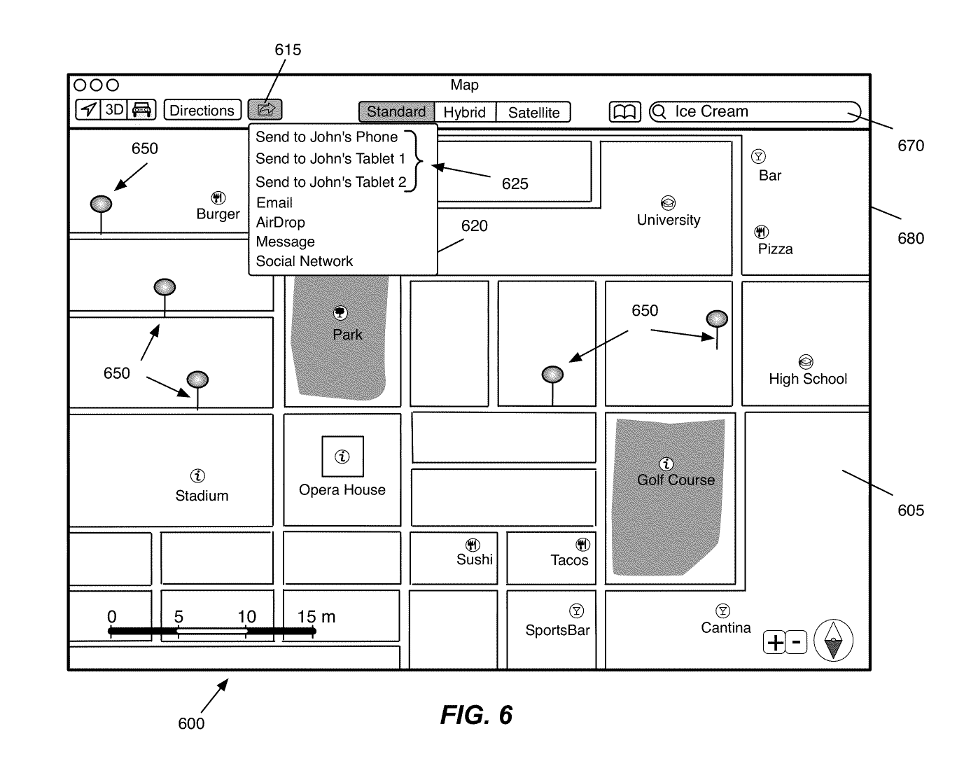

FIG. 6 conceptually illustrates a user interface 600 for sharing a search query in some embodiments of the invention. As shown, a potion of a map 605 is displayed on the display screen 680 of the device. The map shows pins 650 that mark different locations on the map 605.

In the example of FIG. 6, the pins 650 were dropped after a search (as shown in the search field 670) for “ice cream” resulted in finding several grocery stores. As shown, the pins 650 identify several locations related with the word “ice cream” on the map but none of the locations are currently selected (e.g., in contrast to pin 510 that is selected in FIG. 5).

Selecting the button 615 opens a share menu 620 that includes a list 625 of one or more devices to share the pin information. Selection of one of the devices from the list 625 results in sending the search results (e.g., the locations of the identified pins 650) to the selected devices. Some embodiments also share additional information such as the search query (as shown in the search field 670), the region of the map 605, etc., along with the search results.

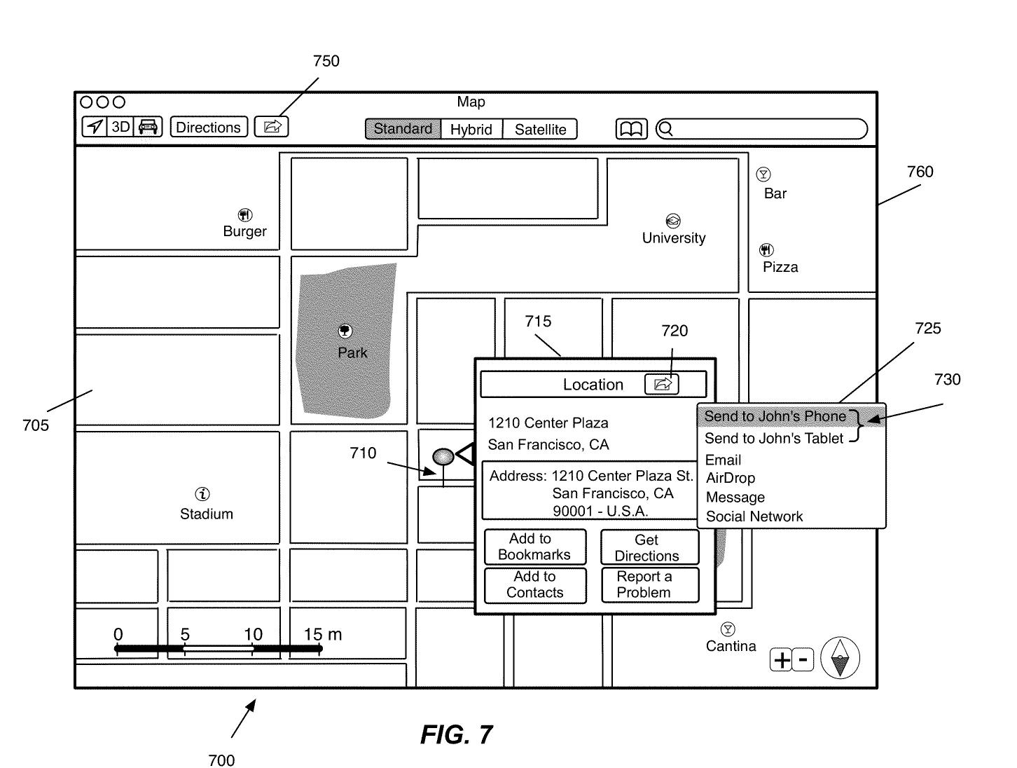

FIG. 7 conceptually illustrates another example of a user interface 700 for sharing a location in some embodiments of the invention. As shown, a potion of a map 705 is displayed on the display screen 760 of the device. The map shows a pin 710 that marks a location on the map 705.

In the example of FIG. 7, the pin 710 was dropped by the user at a location on the map. Dropping a pin allows a user to mark a location on the map, e.g., after searching for an address or identifying a location on the map that interests the user.

In this example, the place where the pin is placed is not associated with any businesses or points of interest identified by the mapping and navigation application. As shown, after the pin 710 is selected, an information menu (e.g., an information card) 715 is displayed with information about the address where the pin is located. The information menu 715 includes a share button 720.

Selecting the share button 720 opens a share menu 725 that includes a list 730 of one or more devices to share the pin information. Selection of one or more devices from the list 730 results in sending the information about the pin to the selected devices. In some embodiments, selection of the share button 750 after menu 715 is displayed also results in menu 725 and the list 730 of the devices to be displayed.

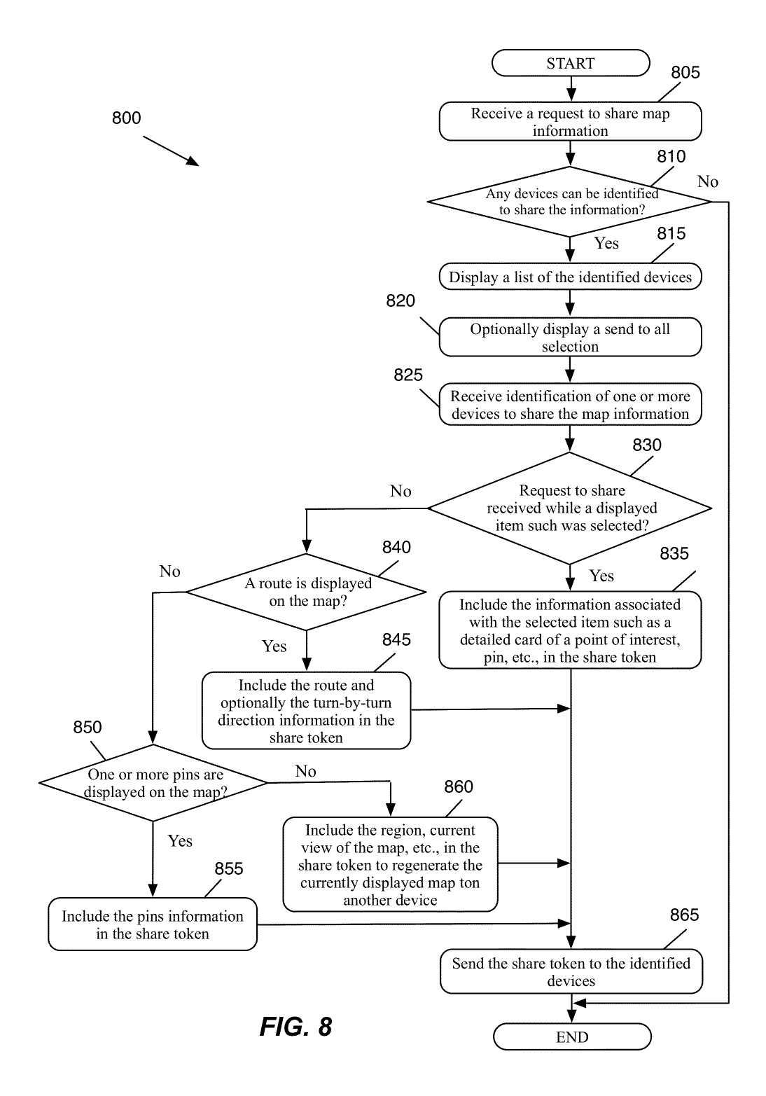

FIG. 8 conceptually illustrates a process 800 for sending map information from a device to a set of associated devices. As shown, the process receives (at 805) a request to share map information with other devices. For instance, the process receives a selection of button 520 or 550 described by reference to FIG. 5, above.

The process then determines (at 110) whether any other devices are associated with the device. If there are no other devices associated with the device, the process ends. If there are no other devices associated with the current devices, some embodiments display menus (such as menu 525 shown in FIG. 5 without a list of devices) to provide other options such as sending an email or sending to social media web sites, etc., to allow the user to share the map information.

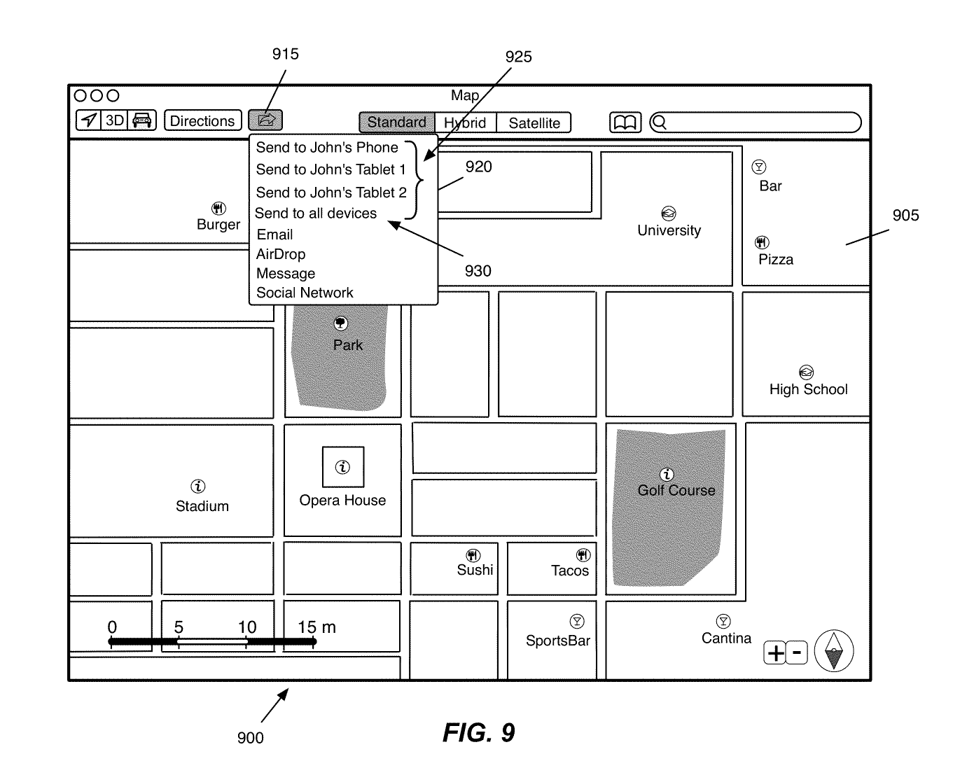

When there are other devices associated with the device, the process displays (at 815) a list of the devices to share the map information. For instance, the process displays the list 530 described by reference to FIG. 5. The process optionally displays (at 820) an option to send the map information to all associated devices. For instance, the process displays an option such as option 930 described by reference to FIG. 9, below. The process then receives (at 825) a selection of one or more devices to share the map information. For instance, the process receives such a selection when the user selects one of the devices included in list 925 or selects the option 930 as shown in FIG. 9.

The process then determines (at 830) whether the request to share map information is received while a map item such as a point of interest, a pin, a search result, etc., is selected. For instance, in FIG. 3, the point of interest 315 is already selected when the share button 335 that was included in the information menu 330 is selected. Similarly, in FIGS. 5 and 7 pins 510 and 710 associated with a search result and a location respectively where selected when the request to share the map information is made by selecting a share button. When the request to share was made when a point of interest, a pin, a search result, etc., is selected, process 800 includes (at 835) the information associated with the selected item in a data structure referred to as a share token that is used to transfer data between devices. This data structure is sent to the selected device in order for the receiving device to display the map information identified on the sending device. The process then proceeds to 865, which is described below.

Otherwise when an item is not selected on the map, the process determines (at 840) whether the request is for sharing a route. For instance, the process determines whether a route such as route 215 was displayed when the request to share was received. If not, the process proceeds to 850, which is described below. Otherwise, the process includes (at 845) the route information and optionally any additional turn-by-turn directions in the share token. For instance, the process includes one or more of the name of the streets, an identification that the mapping and navigation application assigns to a road, direction of turns, length of each section of the route, start and end coordinates of each section of the route, the estimated time to travel each section and the whole route, etc. In some embodiments, when more than one routes are displayed (such as routes 111-113 shown in FIG. 1) the information about all displayed routes is shared. In other embodiments, only the information about a selected (or active route) such as route 112 is shared. The process then proceeds to 865, which is described below.

The process determines (at 850) whether any pins are dropped on the map. If not, the process proceeds to 860, which is described below. Otherwise, the process includes (at 855) the pin information in the share token. For instance, some embodiment (e.g., the example in FIG. 6) share a set of pins that identify the results of a search query when any of the pins being selected. In other embodiments, a set of pins that are dropped by a user but none of them are selected are included in the share token in operation 860. The process then proceeds to 865, which is described below.

The process includes (at 860) information that is required to regenerate the map that is currently displayed on the current device on the selected devices. For instance, some embodiments include one or more of the map region, map coordinates, map zoom level, camera angel, whether the map is displayed as a two-dimensional (2D) map or a three-dimensional (3D) map, etc. in the share token. The process then sends (at 860) the share token to the selected devices. The process then ends.

Process 800 describes the priorities assigned for sharing different map items in some embodiments of the invention. In other embodiments, the items to share are prioritized differently. For instance, some embodiments give the highest priority for to sharing a route when a route is displayed on the map no matter whether any other items such as pins or points of interest are selected. In these embodiments, the position of operations 830-835 and 840-845 in FIG. 8 are switched with each other. In some embodiments, when several items such as a route, a selected point of interest, or a selected pin are displayed, an option is provided (e.g., by displaying a menu) that allows selection of one of the items to share. For instance, when a route is displayed and a pin is selected when a share button is selected, a menu to select either the route or the pin is displayed that allows the selection of one of these items to share.

B. Selecting More than One Device to Share Map Information

Some embodiments allow sharing map information with more than one device at a time. In some of these embodiments, a send to all (or push to all) option is provided that enables the user to send the selected map information to all devices associated with the user. As described in the Architecture Section below, in some embodiments the first associated device that accepts and displays the information consumes the information. In these embodiments, the other associated devices are notified and discard the shared information.

For instance, consider a scenario where a desktop device is associated with 5 other devices. A shared map item such as a route is sent from the desktop device to all other 5 devices using the send to all option. The shared information along with a notification is sent to all other 5 devices. The first device that accepts the notification displays the shared map information. All other devices are notified and discard the shared information. This method avoids receiving the same redundant information on other 4 associated devices.

For instance, a user selects a point of interest or a search result on her desktop device at home and sends the shared item to all her other associated devices. The user then uses a smart phone in her car to display the shared map item and navigate to the shared item. When the user uses her touchpad device at a later time, the user does not get a notification to receive the same shared information on the user touchpad. Accepting and displaying the shared information on the smart phone causes all other associated devices to discard the shared information.

FIG. 9 conceptually illustrates a user interface 900 for sending sharing a currently displayed map view with multiple devices in some embodiments of the invention. As shown, a portion 905 of a map is displayed on the device.

When the share button 915 is selected, a menu 920 is displayed that includes a list 925 of several devices. The list also includes an option 930 to send the map information to all of the displayed devices. When option 930 is selected, the map information (in this example the map region currently displayed on the device) is sent to all displayed devices. Some embodiments instead of listing the devices individually only provide the send to all devices option 930. In these embodiments, when the option 930 is selected, the shared information is sent to all devices associated with the device (e.g., all devices that are registered to the same user through a remote storage and computing service).

### II. Receiving Shared Map Information

Once map information is sent from a device, the device (or devices) that are selected to receive the map information receive a notification that map information to share has arrived. A device that receives the notification can be in different operating states such as locked, unlocked running the mapping and navigation application in the foreground, or unlocked running an application other than the mapping and navigation application in the foreground.

A. Receiving Map Information when the Device is Locked

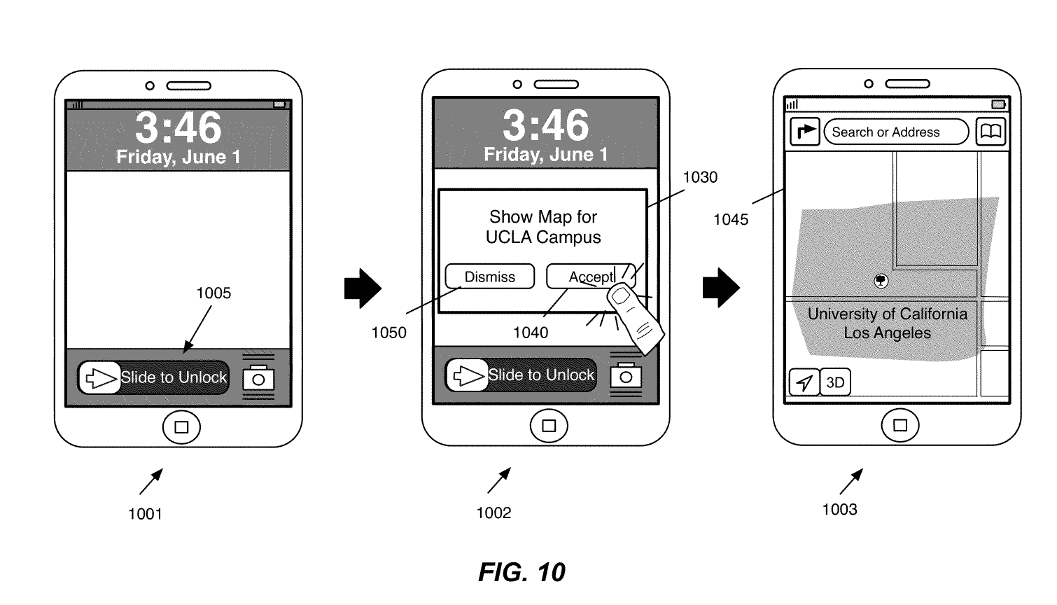

FIG. 10 conceptually illustrates receiving shared map information at a device while the device is in locked mode in some embodiments of the invention. The figure is shown in three stages 1001-1003. In stage 1001, the device is in a locked mode (as indicated by the unlocking slider 1005).

In some embodiments, a device is in locked mode when only a reduced set of controls can be used to provide input into the device. For instance, in some embodiments, locking of the device greatly limits the number of inputs that a user can provide through a touch-sensitive screen of the device. In some embodiments, devices with multiple functions (e.g., mobile phones that run multiple applications) can be placed into locked mode from various applications. In some embodiments, there are multiple ways to place a device into locked mode (e.g., by default after a predetermined period of time elapses between receiving user inputs, by pressing the power switch on the device once, by selecting a menu option, etc.).

In stage 1002, the device receives a notification 1030 that map information to share has arrived. In this example, the notification is in the form of a “Show map for ‘name of the location’” alert. Also, in the embodiment shown in FIG. 10, the notification when the device is in the locked mode does not include an icon for a map. In other embodiments, the notification received when the device is in the locked mode does include an icon for a map (e.g., as shown by the icon 185 in FIG. 1). In stage 1002, the request to receive the map information is accepted (e.g., after an accept button 1040 is selected). On the other hand, if the dismiss button 1050 is selected, the received map information is discarded in some embodiments.

As shown in stage 1003, the mapping and navigation application is activated in the foreground and the same region of the map that was displayed on the sending device is displayed on the receiving device display screen 1045. In some embodiments, the same view (e.g., the same zoom level, the same camera view, same two-dimensional (2D) or three-dimensional (3D) map, etc.) of the map that was displayed on the sending device when the map selection was made is also displayed on the receiving device. In some embodiments (as the illustrated embodiment), the device acceptance of the notification unlocks the device. In other embodiments, the shared map item is displayed on the device display screen while the screen is locked (e.g., the display screen still shows the slide to unlock control 1005 and requires sliding the control 1005 before the device is unlocked).

B. Receiving Map Information when the Mapping and Navigation Application is Running in Foreground

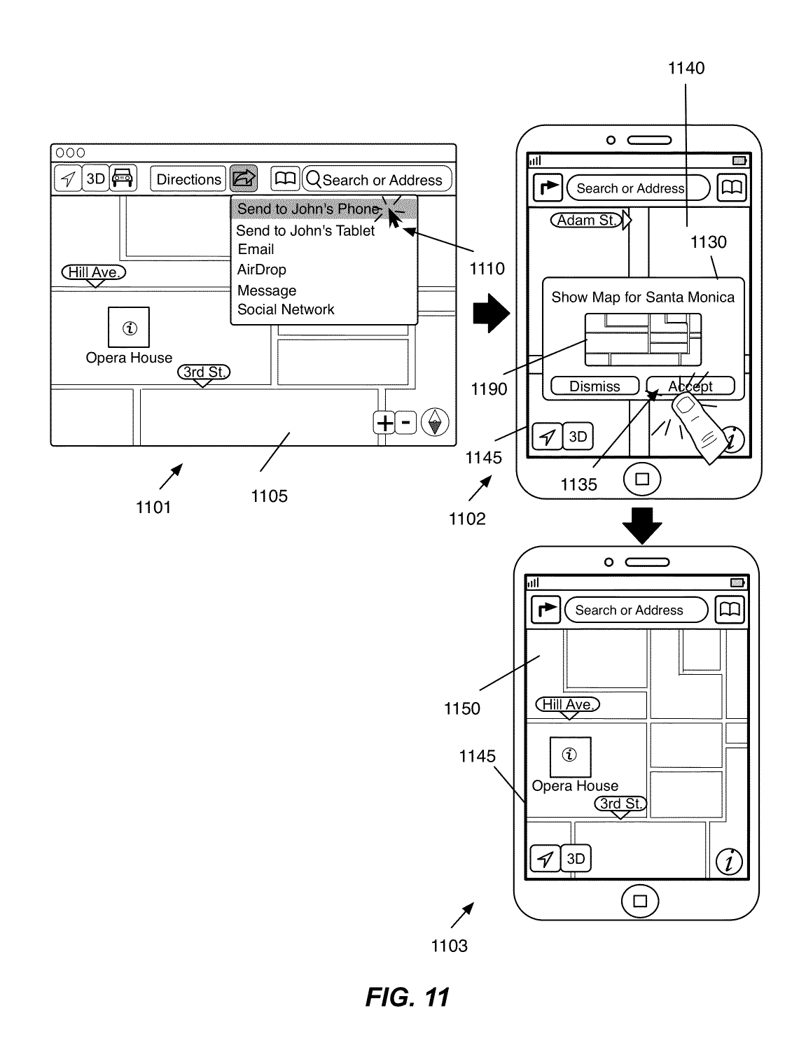

FIG. 11 conceptually illustrates receiving map information while the mapping and navigation application is running in the foreground in some embodiments of the invention. The figure is shown in three stages 1101-1103. In stage 1101, the first device selects John's phone (as shown by the arrow 1110) to receive the current map view displayed on the first device. Stage 1102 shows that the receiving device (John's phone) displays a notification 1130 that a map view to display has received.

As shown in stage 1102, when the notification 1130 arrives, the mapping and navigation application is running in the foreground and a region of a map 1140 is displayed on the display screen 1145 of the receiving device. In this example, the notification is of the form “Show Map for ‘name of map region’”. As shown, the notification in some embodiments also displays a small map 1190. In some embodiments, the displayed map 1190 is a smaller version (or an icon) of the actual map to be displayed. In other embodiments, the small map is a generic image of a map. Yet in other embodiments, the notification does not include an image of a map. Stage 1102 also shows that the user has accepted the notification (as shown by selecting the accept button 1135).

In stage 1103, the map region 1140 that was displayed on the display screen 1145 is replaced by the map region 1150 that was displayed on the first device (as shown by the same streets and landmarks that are displayed on the map 1150 and the map 1105). In the example of FIG. 11, the first and second devices are of different types (e.g., the first device is a desktop and the second device is a smart phone) with different display sizes and different display proportions or aspect ratios. Accordingly, the map shown in stage 1103 is displayed at the same zoom level and camera view as the map shown in stage 1101 but the displayed portion of the map 1150 is adjusted according to the aspect ratios of the display screen of the two devices.

C. Receiving Map Information when the Mapping and Navigation Application is not Running in Foreground

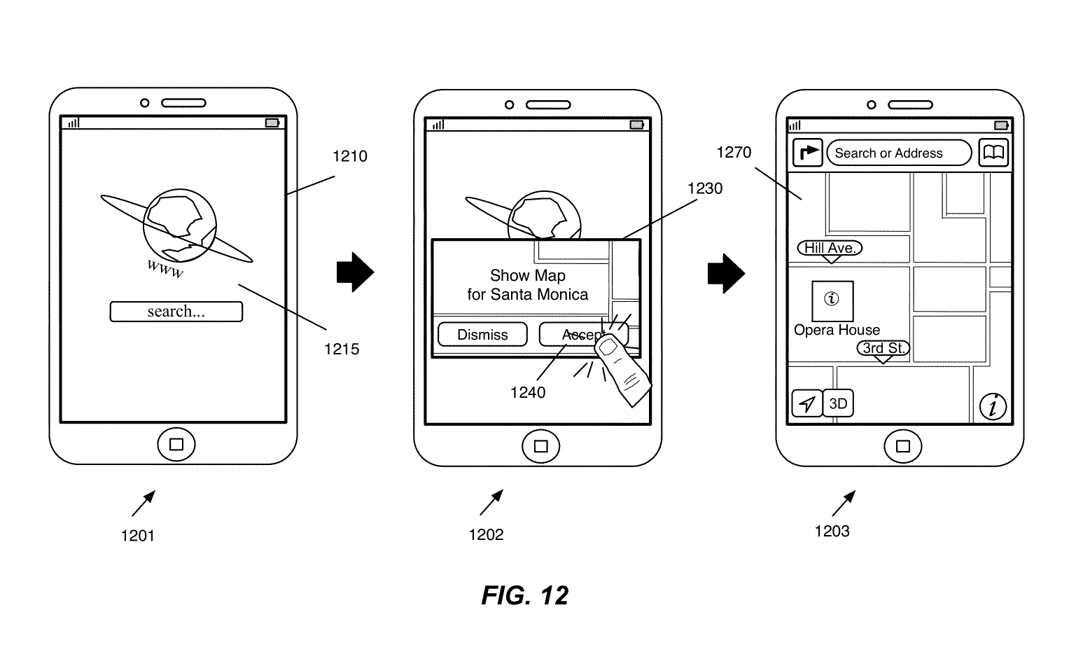

FIG. 12 conceptually illustrates receiving map information while the mapping and navigation application is not running in the foreground in some embodiments of the invention. The figure is shown in three stages 1201-1203. In stage 1201, an application other than the mapping and navigation application (in this example a web browser) is running on the foreground on the device. As shown, the display screen 1210 is showing the web browser 1215 is running.

In stage 1202, a notification 1230 arrives that a map view has received from another device. The user accepts to receive the map information in stage 1202 (e.g., by selecting the accept button 1240). As shown in stage 1203, the application 1215 that was running in the foreground is replaced by the mapping and navigation application that has displayed the map 1270.

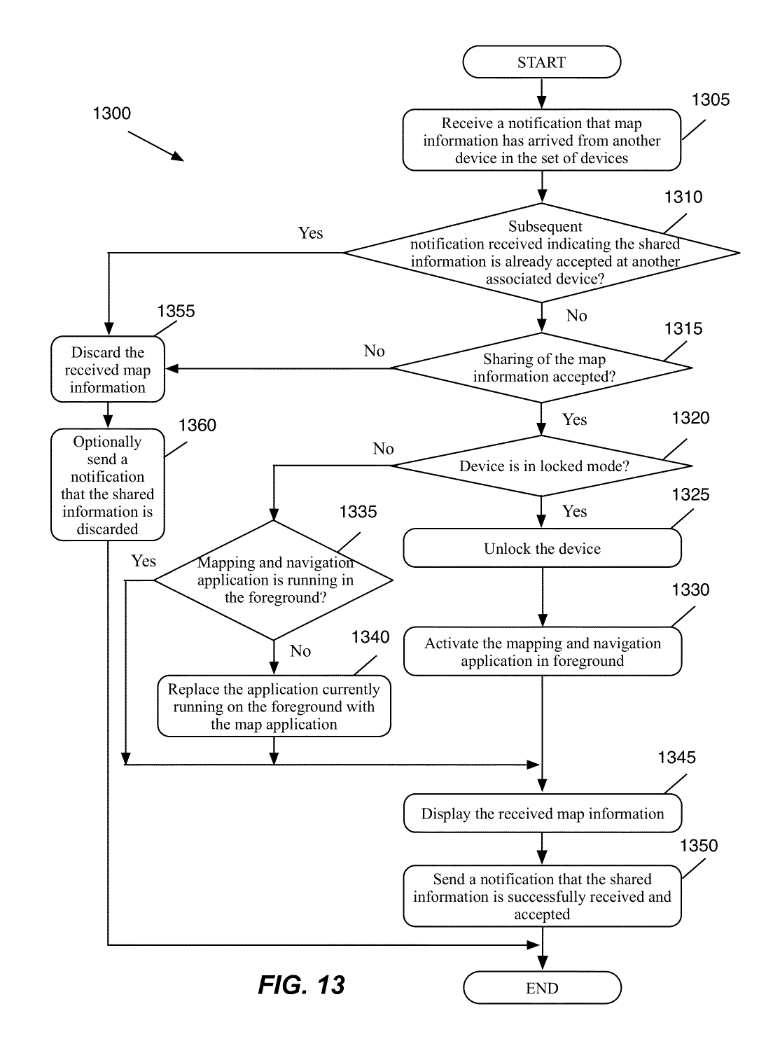

FIG. 13 conceptually illustrates a process 1300 for receiving map information that is pushed into a device from another device. As shown, the process receives (at 1305) a notification that map information has arrived from another device. For instance, the process receives such a notification when process 800 described above sends the share token from the device that is performing process 8100 to the device that is performing process 1300.

Process 1300 then determines (at 1310) whether a subsequent notification is received (i.e., after the notification received at 1305) indicating that shared information is already accepted at another associated device. For instance, when the shared information is sent to several devices using the “send to all” option (as described by reference to FIG. 9, above), the first device that accepts the shared information sends a notification that causes other associated devices to discard the shared information. If not, the process proceeds to 1315, which id described below.

Otherwise, the process discards (at 1355) the shared map information and the associated notification. The process then optionally sends (at 1360) a notification that the device has discarded the shared information. The process then ends.

The process determines (at 1315) whether sharing of the map information was accepted. For instance, the receipt is accepted when a button such as 1040 described by reference to FIG. 10 is selected. If the sharing is accepted, the process proceeds to 1325, which is described below. Otherwise, when sharing is not accepted (e.g., when a button such as the dismiss button 1050 shown in FIG. 10 is selected), the process proceeds to 1355, which was described above. The process then ends.

The process determines (at 1325) whether the device is in locked mode (e.g., as described by reference to FIG. 10, above). If not, the process proceeds to 1335, which is described below. Otherwise, the process unlocks (at 1325) the device. The process then activates (at 1330) the mapping and navigation application in the foreground. The process then proceeds to 1345, which is described below.

When the device was not in the locked mode, the process determines (at 1330) whether the mapping and navigation application is running in the foreground. For instance, in the example described above by reference to FIG. 11, the mapping and navigation application is running in the foreground while in the example of FIG. 12, the mapping and navigation application is not running in the foreground. When the mapping and navigation application is running in the foreground, the process proceeds to 1345, which is described below. Otherwise, the process replaces (at 1340) the application that is currently running in the foreground with the mapping and navigation application (e.g., as described by reference to FIG. 12, above).

The process displays (at 1345) the received map information. The process then sends a notification that the shared information is successfully received and accepted. This notification in some embodiments is received at the sending device to indicate the successful acceptance of the shared information. The notification is also sent to any other associated devices that have received the same shared information (e.g., through the “send to all” option described by reference to FIG. 9, above). The other associated devices use the notification to discard the shared information (as described by reference to operation 1310, above). The process then ends.

In some embodiments, the process (e.g., by using the mapping and navigation application) utilizes the information received in a data structure referred to as a share token and generates the map and/or the shared map information such as a search result, a location, a pin, a point of interest, etc., for displaying on the device display screen. In other embodiments, a set of map servers receive the share token from the device that originated the share request and generate some or all of the map and/or the information to be displayed on the map. The set of servers then send the information to the receiving device to display.

### III. Architecture

A. Sending Map Related Information from One Device to One or More Associated Devices

Some embodiments provide tools for a user to associate different electronic devices such as mobile phones, touchpads, desktop computers, laptop computers, personal assistant devices (PDAs) together. Once the devices are associated together, the user can send map information to his/her other devices.

Some embodiments utilize a service accessible over a network to register or bound devices to a user. Services of different remote storage or remote storage and remote computing (e.g., cloud storage or cloud computing) are used by different embodiments. Once a user selects the map information on a device to share and selects a share button (e.g., buttons 720 or 750 shown in FIG. 7), the list (e.g., the list 730) of other devices associated with the current device is displayed.

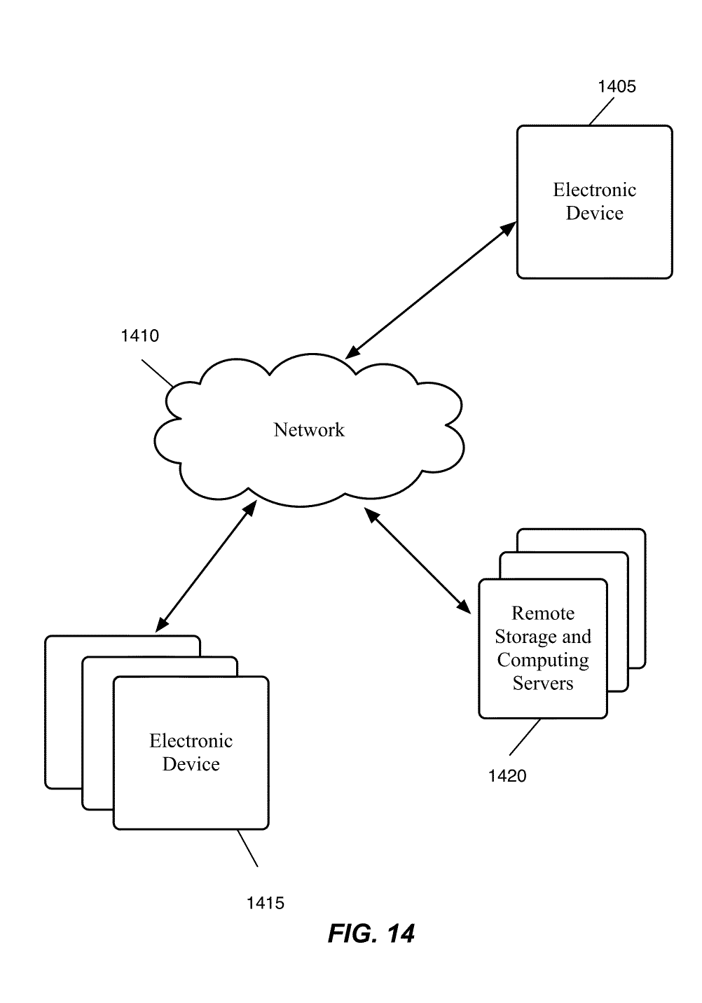

FIG. 14 conceptually illustrates a system level diagram for getting a list of associated devices and sending map related information from one device to other devices in some embodiments of the invention. As shown a set of devices 1405-1410 are connected to each other through one or more networks 1410 such as the Internet, cellular networks, Wi-Fi networks, etc.

As shown, a set of remote storage and remote computing servers 1420 associated with a remote service such as a storage and computing service are connected to the devices 1405-1410 through the network 1410. The set of servers 1420 register users for using the remote storage and computing services. Once a user registers for the remote services, the user can add (or register) the user's different devices such as mobile phones, tablets, touchpads, desktops, laptops, etc., to the remote storage and computing service. The user can also remove or deregister devices that the user has lost, no longer owns, no longer uses, or other wise does want to be registered. The remote servers 1420 maintain the list of registered devices of each user and provide the list to all registered devices of the user.

When one of the devices such as device 1405 receives a user selection to share map information with other devices (e.g., when a share button such as 335 or 350 shown in FIG. 3 is selected) the mapping and navigation application on the device 1405 accesses the list of associated devices (i.e., devices registered to the same user) and displays the list of other devices (e.g., displays the list 345).

When the user of device 1405 selects one or more of the user's other associated devices to share the map information, the mapping and navigation application on device 1405 identifies the map information is be shared. Device 1405 then sends the information to the selected device or devices through the network 1410. For instance, the mapping and navigation application creates a share token (or a data structure) and includes the map information to share in the token. The share token is then sent to the receiving devices. In some embodiments, the map information to share is sent from device 1405 through the network to the set of remote servers 1420 and the set of remote servers relay the map information to the selected associated devices. In some embodiments, the set of remote servers 1420 temporarily stores the data for a particular selected, associated device when the particular selected, associated device is unavailable to receive the data.

In some embodiments, the remote storage and remote computing system also provide an option for more than one user (e.g., a husband and wife, a group of friends, etc.) to mutually authorize to associate some or all of their registered devices to each other in order to share information. In some of these embodiments, the list of associated devices (e.g., the list 730) includes the user's own associated devices as well as other users' associated devices.

1. Use of Identity Services to Push Map Related Data into Devices

Some embodiments utilize a utility to push share tokens from one device to other devices. In some of these embodiments, the same utility is used to register devices and to unregister devices that are no longer used by the user.

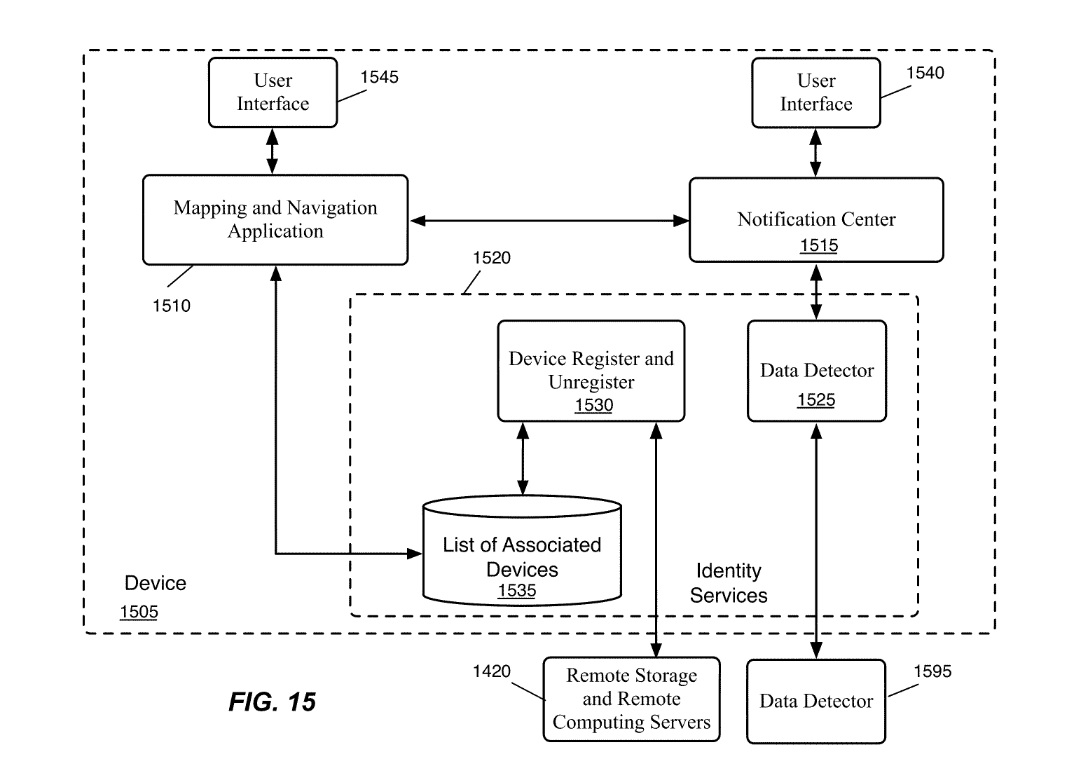

FIG. 15 conceptually illustrates a client side diagram for pushing map information from one device to other device in some embodiments of the invention. As shown, each device 1505 includes a mapping and navigation application 1510, a notification center module 1515, and an identity services utility 1520. The identity services utility 1520 includes a data detector module 1525 and a device register and unregister module 1530. In some embodiments, the identity services utility is a layer of framework used by the device (e.g., by the operating system or a messaging utility) to exchange messages (such as short message service (SMS) or text messages) between the devices.

The device register and unregister module 1530 registers and unregisters devices (e.g., by contacting the set of servers 1420 described by reference to FIG. 14, above). The device register and unregister module maintains an updated list 1535 of associated devices in the device. When a user selects a share button such as buttons 720 and 750 shown in FIG. 7, the mapping information utilizes the list of associated devices 1535 to display the list of associated devices (e.g., the list 730 in FIG. 7) for receiving the shared information.

In addition, when a user selects map information and one or more associated devices to share the information (e.g., through the user interface 1545), the mapping and navigation application 1510 sends the shared map information to notification center 1515. The notification center 1515 sends the shared information along with a notification to the data detector module 1525 of the identity services 1520. The data detector 1525 module of the device 1505 sends the shared information and the notification to the data detector module of the receiving devices. In some embodiments, the mapping and navigation application 1510 includes the shared information in a data structure (or share token), which is sent to the receiving devices.

When a notification arrives from another device, the data detector module 1525 in the device receives the shared information from the data detector module 1595 of the other device. The data detector module 1525 sends the information to the notification center 1515. The notification center displays notifications such as 1030, 1130, and 1230 described by reference to FIGS. 10-12, above. The notification center interacts with a user through the user interface 1540 (e.g., through selection buttons 1040 and 1050 in FIG. 10) to determine whether the sharing the map information is accepted or dismissed.

If sharing is dismissed (e.g., when button 1050 is selected), the notification center dismisses the received share token and optionally sends a notification through the data detector module 1525 that the shared information is discarded. Otherwise, the notification center 1515 passes the share token to mapping and navigation application 1510 to display the information on the device display screen. The notification center 1515 also sends a notification through the data detector module 1525 that the device has accepted the shared information. This notification is used to inform the sending device that the shared information is accepted. The information is also used to inform any other associated devices that has received the shared information through “send to all” option described by reference to FIG. 9. The other associated devices use the notification to discard the shared information.

2. Use of Key-Value Stores to Share Map Related Data into Devices

Some embodiments use a different mechanism to push map related information from one device to other associated devices. These embodiments utilize key-value stores to store map related data to push from one device to other devices. Key-value stores are schema-less ways of storing data by using the data types provided by a programming language.

Some of these embodiments utilize a key-value pair to store data. For instance, the phone number for a point of interest is saved as a key-value pair with two components. The key component (e.g., “1” or “P” or “Phone No.”) identifies the pair as a phone number and the value component (e.g., 818-555-5555) stores the actual phone number.

Some embodiments utilize data structures such as dictionaries that contain key-value pair records. These embodiments utilize an application that synchronizes these data structures among devices. Each device in a group of associated devices adds or removes data from the key-value stores data structures. The differences are pushed across the group of devices.

B. Synchronizing Map Information Through the Recents List

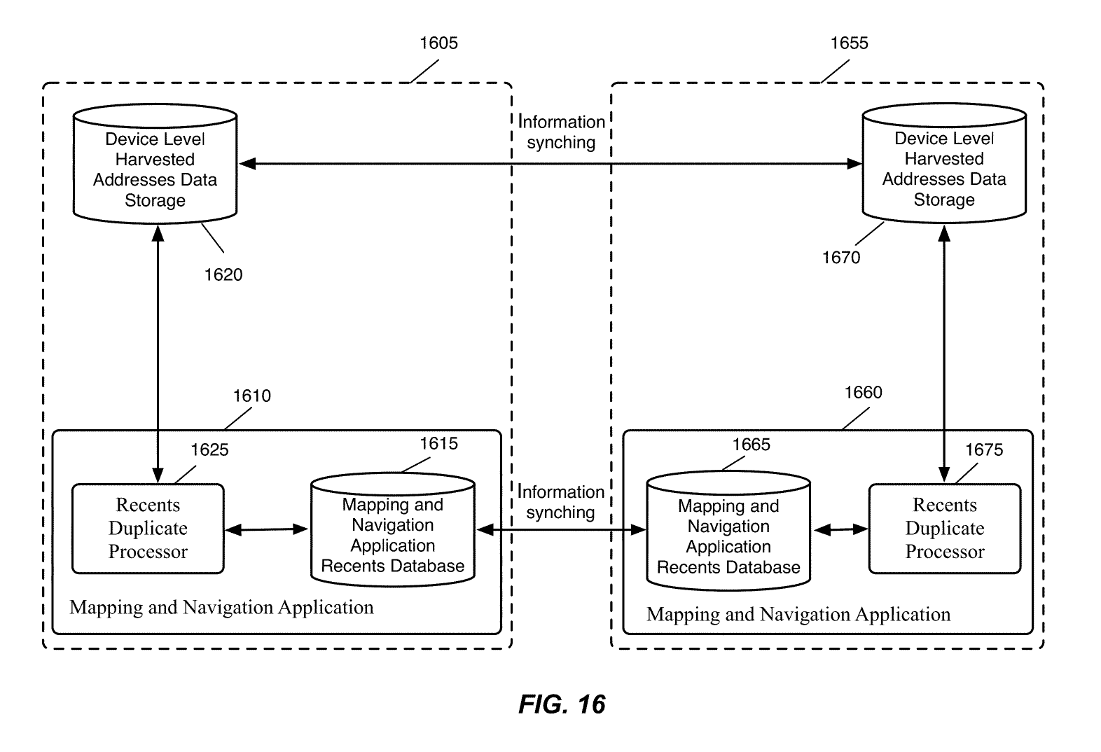

Some embodiments provide a mechanism to push recently accessed map information from one device to other devices. FIG. 16 conceptually illustrates the use of recents list to share map information among different devices. The figure shows only two devices 1605 and 1655 for simplicity but the recents lists are shared among any number of associated devices in some embodiments.

As shown, device 1605 includes a mapping and navigation application 1610. The mapping and navigation application 1610 includes a recents database (or recents list) 1615, which is used to save recently accessed map information such as recent search results, resent map regions displayed on the devices, recent pins dropped, recent routes, etc. Similarly, device 1655 includes a mapping and navigation application 1660 with a recents database 1665.

Each device 1605 and 1655 also includes a device level harvested addresses data storage 1620 and 1670, respectively. The harvested addresses data storages saves various physical addresses that are harvested from the bodies of emails and text messages, captured from locations of calendared appointments, captured based on user interactions with the addresses in emails, browsers, etc.

As shown, the mapping and navigation applications 1610 and 1660 each include a recents duplicate processor (recents deduper or recents de-duplicator) 1625 and 1675, respectively. The recents duplicate processor 1625 searches for map related items such as addresses and point of interest names in the device level harvested addresses data storage 1620 and compares them with the information stored in the mapping and navigation application recents database 1615 to identify duplicate information.

The recents duplicate processor 1625 ignores the duplicate information and incorporates the unique (i.e. the non-duplicate) map related information from the device level harvested addresses data storage 1620 into the mapping and navigation application recents database 1615. In some embodiments, this incorporation is a one-way incorporation while other embodiments also incorporate the non-duplicate information from the mapping and navigation application recents database 1615 into the device level harvested addresses data storage 1620. The recents duplicator processors in other devices also makes similar information incorporation into the recents databases of the corresponding devices.

Some embodiments also synchronize the mapping and navigation application recents databases between the devices that are associated with each other (e.g., registered to the same user in a remote storage and computing service) as described above. Some embodiments automatically synchronize the mapping and navigation application recents databases among the associated devices. Other embodiments provide the user with an option to decide whether the information should be automatically synchronized. Some embodiments also synchronize the device level harvested addresses data storage among the associated devices.

Synchronizing map related information through the mapping and navigation application recents database is an additional mechanism provided in some embodiments to share map related information among devices that are associated with each other. The map related information saved in the recents database in some embodiments includes map-related information such as points of interest, search results, routes, addresses, map regions, queries in map regions, points of interest, pins, locations, etc.

For instance, a user uses the mapping and navigation application on her desktop to search for a coffee shop in Cupertino. The search results in several coffee shops. The user opens the information cards of several coffee shops that are found in the search. The names of the coffee shops, the search region (i.e. Cupertino), as well as the query (i.e., coffee shop) are saved in the mapping and navigation application recents database. At a later time, the user uses her smartphone to start a search (e.g., by selecting the search field 570 shown in FIG. 5). The user is provided the option to use the recently performed search query for coffee shops. The mapping and navigation application in some embodiments also provides the option for searching in a recently searched region (in this example Cupertino) regardless of where the device is currently located.

### IV. Electronic System

Many of the above-described features and applications are implemented as software processes that are specified as a set of instructions recorded on a computer readable storage medium (also referred to as computer readable medium, machine readable medium, machine readable storage). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

A. Mobile Device

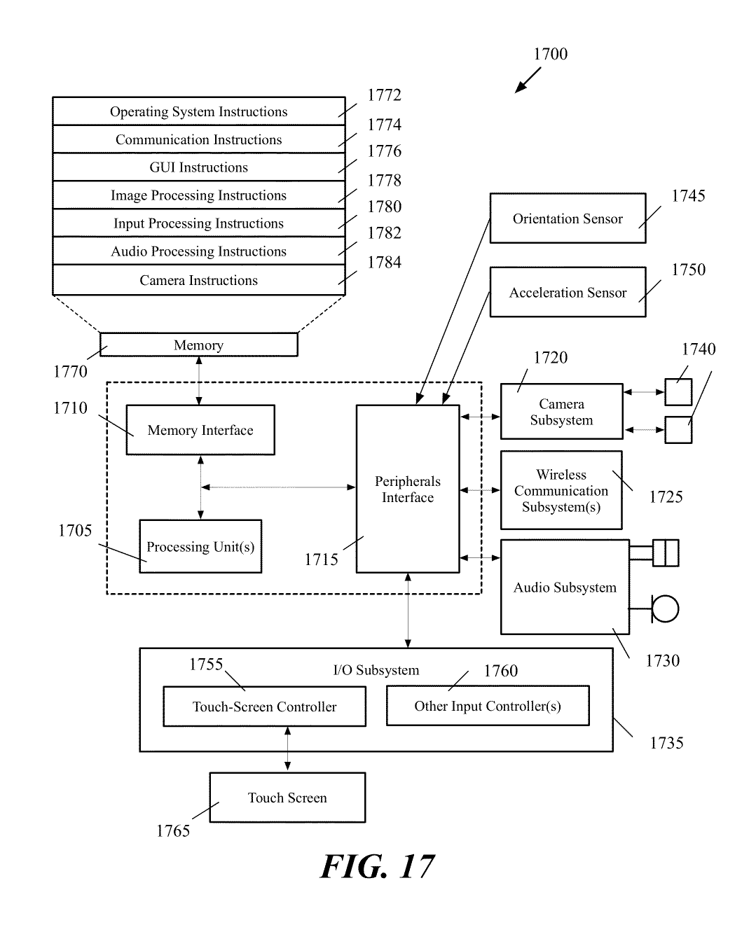

The mapping and navigation applications of some embodiments operate on mobile devices, such as smart phones (e.g., iPhones®) and tablets (e.g., iPads®). FIG. 17 is an example of an architecture 1700 of such a mobile computing device. Examples of mobile computing devices include smartphones, tablets, laptops, etc. As shown, the mobile computing device 1700 includes one or more processing units 1705, a memory interface 1710 and a peripherals interface 1715.

The peripherals interface 1715 is coupled to various sensors and subsystems, including a camera subsystem 1720, a wireless communication subsystem(s) 1725, an audio subsystem 1730, an I/O subsystem 1735, etc. The peripherals interface 1715 enables communication between the processing units 1705 and various peripherals. For example, an orientation sensor 1745 (e.g., a gyroscope) and an acceleration sensor 1750 (e.g., an accelerometer) is coupled to the peripherals interface 1715 to facilitate orientation and acceleration functions.

The camera subsystem 1720 is coupled to one or more optical sensors 1740 (e.g., a charged coupled device (CCD) optical sensor, a complementary metal-oxide-semiconductor (CMOS) optical sensor, etc.). The camera subsystem 1720 coupled with the optical sensors 1740 facilitates camera functions, such as image and/or video data capturing. The wireless communication subsystem 1725 serves to facilitate communication functions. In some embodiments, the wireless communication subsystem 1725 includes radio frequency receivers and transmitters, and optical receivers and transmitters (not shown in FIG. 17). These receivers and transmitters of some embodiments are implemented to operate over one or more communication networks such as a GSM network, a Wi-Fi network, a Bluetooth network, etc. The audio subsystem 1730 is coupled to a speaker to output audio (e.g., to output voice navigation instructions). Additionally, the audio subsystem 1730 is coupled to a microphone to facilitate voice-enabled functions, such as voice recognition (e.g., for searching), digital recording, etc.

The I/O subsystem 1735 involves the transfer between input/output peripheral devices, such as a display, a touch screen, etc., and the data bus of the processing units 1705 through the peripherals interface 1715. The I/O subsystem 1735 includes a touch-screen controller 1755 and other input controllers 1760 to facilitate the transfer between input/output peripheral devices and the data bus of the processing units 1705. As shown, the touch-screen controller 1755 is coupled to a touch screen 1765. The touch-screen controller 1755 detects contact and movement on the touch screen 1765 using any of multiple touch sensitivity technologies. The other input controllers 1760 are coupled to other input/control devices, such as one or more buttons. Some embodiments include a near-touch sensitive screen and a corresponding controller that can detect near-touch interactions instead of or in addition to touch interactions.

The memory interface 1710 is coupled to memory 1770. In some embodiments, the memory 1770 includes volatile memory (e.g., high-speed random access memory), non-volatile memory (e.g., flash memory), a combination of volatile and non-volatile memory, and/or any other type of memory. As illustrated in FIG. 17, the memory 1770 stores an operating system (OS) 1772. The OS 1772 includes instructions for handling basic system services and for performing hardware dependent tasks.

The memory 1770 also includes communication instructions 1774 to facilitate communicating with one or more additional devices; graphical user interface instructions 1776 to facilitate graphic user interface processing; image processing instructions 1778 to facilitate image-related processing and functions; input processing instructions 1780 to facilitate input-related (e.g., touch input) processes and functions; audio processing instructions 1782 to facilitate audio-related processes and functions; and camera instructions 1784 to facilitate camera-related processes and functions. The instructions described above are merely exemplary and the memory 1770 includes additional and/or other instructions in some embodiments. For instance, the memory for a smartphone may include phone instructions to facilitate phone-related processes and functions. Additionally, the memory may include instructions for a mapping and navigation application as well as other applications. The above-identified instructions need not be implemented as separate software programs or modules. Various functions of the mobile computing device can be implemented in hardware and/or in software, including in one or more signal processing and/or application specific integrated circuits.

While the components illustrated in FIG. 17 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 17 may be split into two or more integrated circuits.

B. Computer System

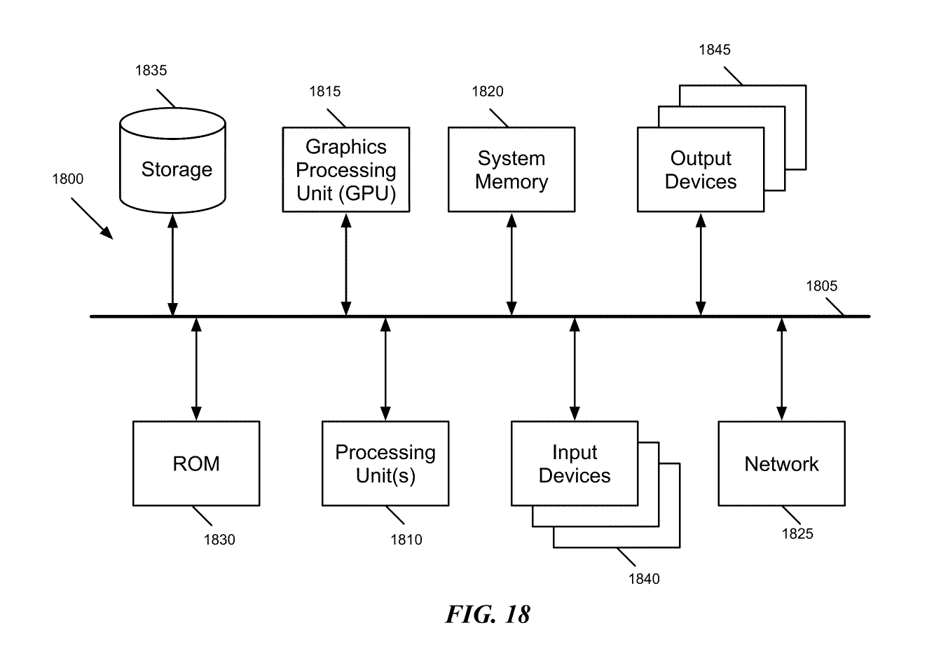

FIG. 18 conceptually illustrates another example of an electronic system 1800 with which some embodiments of the invention are implemented. The electronic system 1800 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1800 includes a bus 1805, processing unit(s) 1810, a graphics processing unit (GPU) 1815, a system memory 1820, a network 1825, a read-only memory 1830, a permanent storage device 1835, input devices 1840, and output devices 1845.

The bus 1805 collectively represents all system, peripheral, and chipset buses that communicatively connect the numerous internal devices of the electronic system 1800. For instance, the bus 1805 communicatively connects the processing unit(s) 1810 with the read-only memory 1830, the GPU 1815, the system memory 1820, and the permanent storage device 1835.

From these various memory units, the processing unit(s) 1810 retrieves instructions to execute and data to process in order to execute the processes of the invention. The processing unit(s) may be a single processor or a multi-core processor in different embodiments. Some instructions are passed to and executed by the GPU 1815. The GPU 1815 can offload various computations or complement the image processing provided by the processing unit(s) 1810.

The read-only-memory (ROM) 1830 stores static data and instructions that are needed by the processing unit(s) 1810 and other modules of the electronic system. The permanent storage device 1835, on the other hand, is a read-and-write memory device. This device is a non-volatile memory unit that stores instructions and data even when the electronic system 1800 is off. Some embodiments of the invention use a mass-storage device (such as a magnetic or optical disk and its corresponding disk drive, integrated flash memory) as the permanent storage device 1835.

Other embodiments use a removable storage device (such as a floppy disk, flash memory device, etc., and its corresponding drive) as the permanent storage device. Like the permanent storage device 1835, the system memory 1820 is a read-and-write memory device. However, unlike storage device 1835, the system memory 1820 is a volatile read-and-write memory, such a random access memory. The system memory 1820 stores some of the instructions and data that the processor needs at runtime. In some embodiments, the invention's processes are stored in the system memory 1820, the permanent storage device 1835, and/or the read-only memory 1830. For example, the various memory units include instructions for processing multimedia clips in accordance with some embodiments. From these various memory units, the processing unit(s) 1810 retrieves instructions to execute and data to process in order to execute the processes of some embodiments.

The bus 1805 also connects to the input and output devices 1840 and 1845. The input devices 1840 enable the user to communicate information and select commands to the electronic system. The input devices 1840 include alphanumeric keyboards and pointing devices (also called “cursor control devices”), cameras (e.g., webcams), microphones or similar devices for receiving voice commands, etc. The output devices 1845 display images generated by the electronic system or otherwise output data. The output devices 1845 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 18, bus 1805 also couples electronic system 1800 to a network 1825 through a network adapter (not shown). In this manner, the computer can be a part of a network of computers (such as a local area network (“LAN”), a wide area network (“WAN”), or an Intranet), or a network of networks, such as the Internet. Any or all components of electronic system 1800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

### V. Map Service Environment

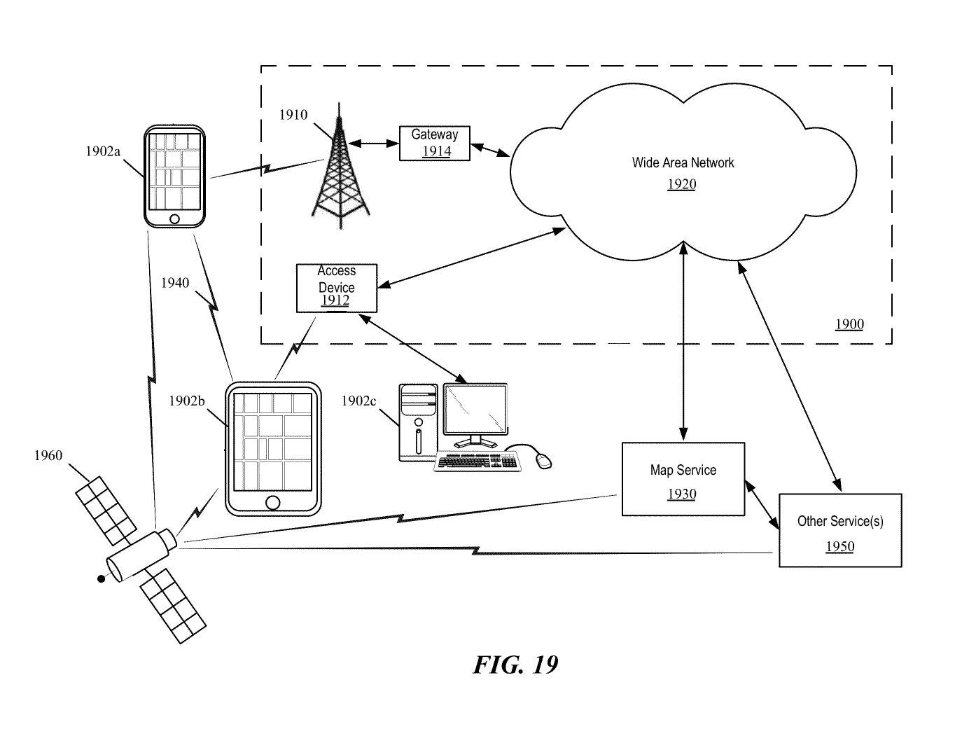

Various embodiments may operate within a map service operating environment. FIG. 19 conceptually illustrates a map service operating environment, according to some embodiments. A map service 1930 (also referred to as mapping service) may provide map services for one or more client devices 1902a-1902c in communication with the map service 1930 through various communication methods and protocols. A map service 1930 in some embodiments provides map information and other map-related data, such as two-dimensional map image data (e.g., aerial view of roads utilizing satellite imagery), three-dimensional map image data (e.g., traversable map with three-dimensional features, such as buildings), route and direction calculations (e.g., ferry route calculations or directions between two points for a pedestrian), real-time navigation data (e.g., turn-by-turn visual navigation data in two or three dimensions), location data (e.g., where the client device is currently located), and other geographic data (e.g., wireless network coverage, weather, traffic information, or nearby points-of-interest). In various embodiments, the map service data may include localized labels for different countries or regions. Localized labels may be utilized to present map labels (e.g., street names, city names, points of interest) in different languages on client devices. Client devices 1902a-1902c may utilize these map services by obtaining map service data. Client devices 1902a-1902c may implement various techniques to process map service data. Client devices 1902a-1902c may then provide map services to various entities, including, but not limited to, users, internal software or hardware modules, and/or other systems or devices external to the client devices 1902a-1902c.

In some embodiments, a map service is implemented by one or more nodes in a distributed computing system. Each node may be assigned one or more services or components of a map service. Some nodes may be assigned the same map service or component of a map service. A load balancing node in some embodiments distributes access or requests to other nodes within a map service. In some embodiments a map service is implemented as a single system, such as a single server. Different modules or hardware devices within a server may implement one or more of the various services provided by a map service.

A map service in some embodiments provides map services by generating map service data in various formats. In some embodiments, one format of map service data is map image data. Map image data provides image data to a client device so that the client device may process the image data (e.g., rendering and/or displaying the image data as a two-dimensional or three-dimensional map). Map image data, whether in two or three dimensions, may specify one or more map tiles. A map tile may be a portion of a larger map image. Assembling together the map tiles of a map produces the original map. Tiles may be generated from map image data, routing or navigation data, or any other map service data. In some embodiments map tiles are raster-based map tiles, with tile sizes ranging from any size both larger and smaller than a commonly-used 256 pixel by 256 pixel tile. Raster-based map tiles may be encoded in any number of standard digital image representations including, but not limited to, Bitmap (.bmp), Graphics Interchange Format (.gif), Joint Photographic Experts Group (.jpg, .jpeg, etc.), Portable Networks Graphic (.png), or Tagged Image File Format (.tiff). In some embodiments, map tiles are vector-based map tiles, encoded using vector graphics, including, but not limited to, Scalable Vector Graphics (.svg) or a Drawing File (.drw). Some embodiments also include tiles with a combination of vector and raster data. Metadata or other information pertaining to the map tile may also be included within or along with a map tile, providing further map service data to a client device. In various embodiments, a map tile is encoded for transport utilizing various standards and/or protocols, some of which are described in examples below.

In various embodiments, map tiles may be constructed from image data of different resolutions depending on zoom level. For instance, for low zoom level (e.g., world or globe view), the resolution of map or image data need not be as high relative to the resolution at a high zoom level (e.g., city or street level). For example, when in a globe view, there may be no need to render street level artifacts as such objects would be so small as to be negligible in many cases.

A map service in some embodiments performs various techniques to analyze a map tile before encoding the tile for transport. This analysis may optimize map service performance for both client devices and a map service. In some embodiments map tiles are analyzed for complexity, according to vector-based graphic techniques, and constructed utilizing complex and non-complex layers. Map tiles may also be analyzed for common image data or patterns that may be rendered as image textures and constructed by relying on image masks. In some embodiments, raster-based image data in a map tile contains certain mask values, which are associated with one or more textures. Some embodiments also analyze map tiles for specified features that may be associated with certain map styles that contain style identifiers.

Other map services generate map service data relying upon various data formats separate from a map tile in some embodiments. For instance, map services that provide location data may utilize data formats conforming to location service protocols, such as, but not limited to, Radio Resource Location services Protocol (RRLP), TIA 801 for Code Division Multiple Access (CDMA), Radio Resource Control (RRC) position protocol, or LTE Positioning Protocol (LPP). Embodiments may also receive or request data from client devices identifying device capabilities or attributes (e.g., hardware specifications or operating system version) or communication capabilities (e.g., device communication bandwidth as determined by wireless signal strength or wire or wireless network type).

A map service may obtain map service data from internal or external sources. For example, satellite imagery used in map image data may be obtained from external services, or internal systems, storage devices, or nodes. Other examples may include, but are not limited to, GPS assistance servers, wireless network coverage databases, business or personal directories, weather data, government information (e.g., construction updates or road name changes), or traffic reports. Some embodiments of a map service may update map service data (e.g., wireless network coverage) for analyzing future requests from client devices.

Various embodiments of a map service may respond to client device requests for map services. These requests may be for a specific maps or portions of a map. Some embodiments format requests for a map as requests for certain map tiles. In some embodiments, requests also supply the map service with starting locations (or current locations) and destination locations for a route calculation. A client device may also request map service rendering information, such as map textures or style sheets. In at least some embodiments, requests are also one of a series of requests implementing turn-by-turn navigation. Requests for other geographic data may include, but are not limited to, requests for current location, wireless network coverage, weather, traffic information, or nearby points-of-interest.

A map service, in some embodiments, analyzes client device requests to optimize a device or map service operation. For instance, a map service may recognize that the location of a client device is in an area of poor communications (e.g., weak wireless signal) and send more map service data to supply a client device in the event of loss in communication or send instructions to utilize different client hardware (e.g., orientation sensors) or software (e.g., utilize wireless location services or Wi-Fi positioning instead of GPS-based services). In another example, a map service may analyze a client device request for vector-based map image data and determine that raster-based map data better optimizes the map image data according to the image's complexity. Embodiments of other map services may perform similar analysis on client device requests and, as such, the above examples are not intended to be limiting.

Various embodiments of client devices (e.g., client devices 1902a-1902c) are implemented on different portable-multifunction device types. Client devices 1902a-1902c utilize map service 1930 through various communication methods and protocols. In some embodiments, client devices 1902a-1902c obtain map service data from map service 1930. Client devices 1902a-1902c request or receive map service data. Client devices 1902a-1902c then process map service data (e.g., render and/or display the data) and may send the data to another software or hardware module on the device or to an external device or system.

A client device, according to some embodiments, implements techniques to render and/or display maps. These maps may be requested or received in various formats, such as map tiles described above. A client device may render a map in two-dimensional or three-dimensional views. Some embodiments of a client device display a rendered map and allow a user, system, or device providing input to manipulate a virtual camera in the map, changing the map display according to the virtual camera's position, orientation, and field-of-view. Various forms and input devices are implemented to manipulate a virtual camera. In some embodiments, touch input, through certain single or combination gestures (e.g., touch-and-hold or a swipe) manipulate the virtual camera. Other embodiments allow manipulation of the device's physical location to manipulate a virtual camera. For instance, a client device may be tilted up from its current position to manipulate the virtual camera to rotate up. In another example, a client device may be tilted forward from its current position to move the virtual camera forward. Other input devices to the client device may be implemented including, but not limited to, auditory input (e.g., spoken words), a physical keyboard, mouse, and/or a joystick.

Some embodiments provide various visual feedback to virtual camera manipulations, such as displaying an animation of possible virtual camera manipulations when transitioning from two-dimensional map views to three-dimensional map views. Some embodiments also allow input to select a map feature or object (e.g., a building) and highlight the object, producing a blur effect that maintains the virtual camera's perception of three-dimensional space.

In some embodiments, a client device implements a navigation system (e.g., turn-by-turn navigation). A navigation system provides directions or route information, which may be displayed to a user. Some embodiments of a client device request directions or a route calculation from a map service. A client device may receive map image data and route data from a map service. In some embodiments, a client device implements a turn-by-turn navigation system, which provides real-time route and direction information based upon location information and route information received from a map service and/or other location system, such as a Global Positioning Satellite (GPS). A client device may display map image data that reflects the current location of the client device and update the map image data in real-time. A navigation system may provide auditory or visual directions to follow a certain route.

A virtual camera is implemented to manipulate navigation map data according to some embodiments. In some embodiments, the client devices allow the device to adjust the virtual camera display orientation to bias toward the route destination. Some embodiments also allow the virtual camera to navigate turns by simulating the inertial motion of the virtual camera.

Client devices implement various techniques to utilize map service data from map service. Some embodiments implement some techniques to optimize rendering of two-dimensional and three-dimensional map image data. In some embodiments, a client device locally stores rendering information. For instance, a client stores a style sheet, which provides rendering directions for image data containing style identifiers. In another example, common image textures may be stored to decrease the amount of map image data transferred from a map service. Client devices in different embodiments implement various modeling techniques to render two-dimensional and three-dimensional map image data, examples of which include, but are not limited to: generating three-dimensional buildings out of two-dimensional building footprint data; modeling two-dimensional and three-dimensional map objects to determine the client device communication environment; generating models to determine whether map labels are seen from a certain virtual camera position; and generating models to smooth transitions between map image data. In some embodiments, the client devices also order or prioritize map service data in certain techniques. For instance, a client device detects the motion or velocity of a virtual camera, which if exceeding certain threshold values, lower-detail image data is loaded and rendered for certain areas. Other examples include: rendering vector-based curves as a series of points, preloading map image data for areas of poor communication with a map service, adapting textures based on display zoom level, or rendering map image data according to complexity.

In some embodiments, client devices communicate utilizing various data formats separate from a map tile. For instance, some client devices implement Assisted Global Positioning Satellites (A-GPS) and communicate with location services that utilize data formats conforming to location service protocols, such as, but not limited to, Radio Resource Location services Protocol (RRLP), TIA 801 for Code Division Multiple Access (CDMA), Radio Resource Control (RRC) position protocol, or LTE Positioning Protocol (LPP). Client devices may also receive GPS signals directly. Embodiments may also send data, with or without solicitation from a map service, identifying the client device's capabilities or attributes (e.g., hardware specifications or operating system version) or communication capabilities (e.g., device communication bandwidth as determined by wireless signal strength or wire or wireless network type).

FIG. 19 illustrates one possible embodiment of an operating environment 1900 for a map service 1930 and client devices 1902a-1902c. In some embodiments, devices 1902a, 1902b, and 1902c communicate over one or more wire or wireless networks 1910. For example, wireless network 1910, such as a cellular network, can communicate with a wide area network (WAN) 1920, such as the Internet, by use of gateway 1914. A gateway 1914 in some embodiments provides a packet oriented mobile data service, such as General Packet Radio Service (GPRS), or other mobile data service allowing wireless networks to transmit data to other networks, such as wide area network 1920. Likewise, access device 1912 (e.g., IEEE 802.11g wireless access device) provides communication access to WAN 1920. Devices 1902a and 1902b can be any portable electronic or computing device capable of communicating with a map service. Device 1902c can be any non-portable electronic or computing device capable of communicating with a map service.

In some embodiments, both voice and data communications are established over wireless network 1910 and access device 1912. For instance, device 1902a can place and receive phone calls (e.g., using voice over Internet Protocol (VoIP) protocols), send and receive e-mail messages (e.g., using Simple Mail Transfer Protocol (SMTP) or Post Office Protocol 3 (POP3)), and retrieve electronic documents and/or streams, such as web pages, photographs, and videos, over wireless network 1910, gateway 1914, and WAN 1920 (e.g., using Transmission Control Protocol/Internet Protocol (TCP/IP) or User Datagram Protocol (UDP)). Likewise, in some implementations, devices 1902b and 1902c can place and receive phone calls, send and receive e-mail messages, and retrieve electronic documents over access device 1912 and WAN 1920. In various embodiments, any of the illustrated client devices may communicate with map service 1930 and/or other service(s) 1950 using a persistent connection established in accordance with one or more security protocols, such as the Secure Sockets Layer (SSL) protocol or the Transport Layer Security (TLS) protocol.

Devices 1902a and 1902b can also establish communications by other means. For example, wireless device 1902a can communicate with other wireless devices (e.g., other devices 1902b, cell phones, etc.) over the wireless network 1910. Likewise devices 1902a and 1902b can establish peer-to-peer communications 1940 (e.g., a personal area network) by use of one or more communication subsystems, such as Bluetooth® communication from Bluetooth Special Interest Group, Inc. of Kirkland, Wash. Device 1902c can also establish peer to peer communications with devices 1902a or 1902b (not shown). Other communication protocols and topologies can also be implemented. Devices 1902a and 1902b may also receive Global Positioning Satellite (GPS) signals from GPS satellites 1960.

Devices 1902a, 1902b, and 1902c can communicate with map service 1930 over one or more wired and/or wireless networks, 1912 or 1910. For instance, map service 1930 can provide map service data to rendering devices 1902a, 1902b, and 1902c. Map service 1930 may also communicate with other services 1950 to obtain data to implement map services. Map service 1930 and other services 1950 may also receive GPS signals from GPS satellites 1960.

In various embodiments, map service 1930 and/or other service(s) 1950 are configured to process search requests from any of the client devices. Search requests may include but are not limited to queries for businesses, addresses, residential locations, points of interest, or some combination thereof. Map service 1930 and/or other service(s) 1950 may be configured to return results related to a variety of parameters including but not limited to a location entered into an address bar or other text entry field (including abbreviations and/or other shorthand notation), a current map view (e.g., user may be viewing one location on the multifunction device while residing in another location), current location of the user (e.g., in cases where the current map view did not include search results), and the current route (if any). In various embodiments, these parameters may affect the composition of the search results (and/or the ordering of the search results) based on different priority weightings. In various embodiments, the search results that are returned may be a subset of results selected based on specific criteria including but not limited to a quantity of times the search result (e.g., a particular point of interest) has been requested, a measure of quality associated with the search result (e.g., highest user or editorial review rating), and/or the volume of reviews for the search results (e.g., the number of times the search result has been review or rated).

In various embodiments, map service 1930 and/or other service(s) 1950 are configured to provide auto-complete search results that are displayed on the client device, such as within the mapping application. For instance, auto-complete search results may populate a portion of the screen as the user enters one or more search keywords on the multifunction device. In some cases, this feature may save the user time as the desired search result may be displayed before the user enters the full search query. In various embodiments, the auto complete search results may be search results found by the client on the client device (e.g., bookmarks or contacts), search results found elsewhere (e.g., from the Internet) by map service 1930 and/or other service(s) 1950, and/or some combination thereof. As is the case with commands, any of the search queries may be entered by the user via voice or through typing. The multifunction device may be configured to display search results graphically within any of the map display described herein. For instance, a pin or other graphical indicator may specify locations of search results as points of interest. In various embodiments, responsive to a user selection of one of these points of interest (e.g., a touch selection, such as a tap), the multifunction device is configured to display additional information about the selected point of interest including but not limited to ratings, reviews or review snippets, hours of operation, store status (e.g., open for business, permanently closed, etc.), and/or images of a storefront for the point of interest. In various embodiments, any of this information may be displayed on a graphical information card that is displayed in response to the user's selection of the point of interest.

In various embodiments, map service 1930 and/or other service(s) 1950 provide one or more feedback mechanisms to receive feedback from client devices 1902a-1902c. For instance, client devices may provide feedback on search results to map service 1930 and/or other service(s) 1950 (e.g., feedback specifying ratings, reviews, temporary or permanent business closures, errors etc.); this feedback may be used to update information about points of interest in order to provide more accurate or more up-to-date search results in the future. In some embodiments, map service 1930 and/or other service(s) 1950 may provide testing information to the client device (e.g., an A/B test) to determine which search results are best. For instance, at random intervals, the client device may receive and present two search results to a user and allow the user to indicate the best result. The client device may report the test results to map service 1930 and/or other service(s) 1950 to improve future search results based on the chosen testing technique, such as an A/B test technique in which a baseline control sample is compared to a variety of single-variable test samples in order to improve results.

While the invention has been described with reference to numerous specific details, one of ordinary skill in the art will recognize that the invention can be embodied in other specific forms without departing from the spirit of the invention. For instance, many of the figures illustrate various touch gestures (e.g., taps). However, many of the illustrated operations could be performed via different touch gestures (e.g., double tap gesture, press and hold gesture, swipe instead of tap, etc.) or by non-touch input (e.g., using a cursor controller, a keyboard, a touchpad/trackpad, a near-touch sensitive screen, etc.). In addition, a number of the figures (including FIGS. 8 and 13) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

What is claimed is:

1. A method for sharing map information among a plurality of associated devices, the method comprising:
identifying a set of items to share related to a map displayed at a first device;
displaying a list of selectable, associated devices for receiving the identified set of items, the list of associated devices provided by a remote service; and
sending data regarding the identified set of items from the first device to a set of associated devices that are selected in the displayed list.

2. The method of claim 1, wherein sending data comprises sending data regarding the identified set of items to a set of servers for relaying the data to each device in the set of associated devices, wherein said set of servers temporarily stores the data for a particular device in the set of associate devices when the particular device is unavailable to receive the data.

3. The method of claim 1, wherein the remote service comprises a set of servers for identifying a plurality of associated devices and for informing each device in the plurality of associated devices of other devices in the plurality.

4. The method of claim 1 further comprising sending a notification with the identified set of items from the first device to each device in the set of associated devices.

5. The method of claim 4 further comprising:
displaying the notification at a second device in the set of associated devices while the second device in a locked mode, wherein when a device is in the locked mode, access is prevented to a plurality of applications installed on the device until an input to unlock the display screen is received;
receiving an acceptance of the notification at the second device; and
displaying the set of items to share on the second device.

6. The method of claim 5, wherein receiving the acceptance of the notification unlocks the second device.

7. The method of claim 5, wherein the set of items to share are displayed while the second device is still in the locked mode.

8. The method of claim 4 further comprising:
displaying the notification at a second device in the set of associated devices while a mapping and navigation application is active on a foreground of the second device;
receiving an acceptance of the notification at the second device; and
displaying the set of items to share on the second device by the mapping and navigation application.

9. The method of claim 4 further comprising:
displaying the notification at a second device in the set of associated devices while an application other than a mapping and navigation application is active on a foreground of the second device;
receiving an acceptance of the notification at the second device;
replacing the application active on the foreground with a mapping and navigation application; and
displaying the set of items to share on the second device by the mapping and navigation application.

10. A non-transitory machine-readable medium storing a program for sharing map information among a plurality of associated devices, the program executable by at least one processing unit, the program comprising sets of instructions for:
identifying a set of items to share related to a map displayed at a first device;
displaying a list of selectable, associated devices for receiving the identified set of items, the list of associated devices provided by a remote service; and
sending data regarding the identified set of items from the first device to a set of associated device that are selected in the displayed list.

11. The non-transitory machine-readable medium of claim 10, wherein the set of instructions for sending data comprises a set of instructions for sending data regarding the identified set of items to a set of servers for relaying the data to each device in the set of associated devices, wherein said set of servers temporarily stores the data for a particular device in the set of associated devices when the particular device is unavailable to receive the data.

12. The non-transitory machine-readable medium of claim 10, wherein the selected associated devices comprise a plurality of devices including a second device, the program further comprising sets of instructions for:
sending a notification regarding an acceptance of the shared item from the second device to each of the other devices in the set of associated devices; and
discarding the data regarding the identified set of items at each of the other devices in the set of associated devices after receiving the notification from the second device.

13. The non-transitory machine-readable medium of claim 10, wherein the set of instructions for identifying the set of items to share comprises a set of instructions for identifying a route as the set of items to share when the displayed map comprises the route.

14. The non-transitory machine-readable medium of claim 10, wherein the set of instructions for identifying the set of items to share comprises a set of instructions for identifying a selected item as the set of items to share when the item is selected on the displayed map.

15. The non-transitory machine-readable medium of claim 14, wherein the selected item comprises one of a point of interest and a location displayed on the map.

16. The non-transitory machine-readable medium of claim 10, wherein the set of instructions for identifying a set of items to share comprises a set of instructions for identifying a set of marked locations as the set of items to share when the set of locations are marked on the map in response to a search query and no item on the map is selected.

17. The non-transitory machine-readable medium of claim 10, wherein the set of instructions for identifying a set of items to share comprises a set of instructions for identifying a region of the displayed map as the set of items to share when the displayed map does not comprise a route, no items are selected on the map, and no search results are shown on the map.

18. The non-transitory machine-readable medium of claim 17, the program further comprising a set of instructions for including a zoom level and a camera view of the displayed map in the set of items to share.

19. The non-transitory machine-readable medium of claim 10, wherein the first device and the associated devices displayed in the list are registered to a same user through the remote service.

20. A device comprising:
a set of processing units; and
a non-transitory machine-readable medium storing a program for sharing map information among a plurality of associated devices, the program executable by at least one processing unit, the program comprising sets of instructions for:
identifying a set of items to share related to a map displayed at a first device;
displaying a list of selectable, associated devices for receiving the identified set of items, the list of associated devices provided by a remote service; and
sending data regarding the identified set of items from the first device to a set of associated device that are selected in the displayed list

21. The device of claim 20, wherein the set of instructions for sending data comprises a set of instructions for sending data regarding the identified set of items to a set of servers for relaying the data to each device in set of associated devices, wherein said set of servers temporarily stores the data for a particular device in the set of associated devices when the particular device is unavailable to receive the data.

22. The device of claim 20, wherein the remote service comprises a set of servers for identifying a plurality of associated devices and for informing each device in the plurality of associated devices of other devices in the plurality.

23. The device of claim 20, wherein the set of instructions for identifying the set of items on a displayed map to share comprises a set of instructions for identifying a route as the set of items to share when the displayed map comprises the route.

24. The device of claim 20, wherein the set of instructions for identifying the set of items on a displayed map to share comprises a set of instructions for identifying a selected item as the set of items to share when the item is selected on the displayed map.

25. The device of claim 24, wherein the selected item comprises one of a point of interest and a location displayed on the map.
